(19) United States
(12) Patent Application Publication
(10) Pub. No.: US 2023/0316280 A1
(43) Pub. Date: Oct. 5, 2023

(54) MACHINE LEARNING MODEL FOR FRAUD REDUCTION

(71) Applicant: Block, Inc., San Francisco, CA (US)

(72) Inventors: Mohsen Sardari, Burlingame, CA (US); Angelo Monteux, El Cerrito, CA (US); Michael Woods, San Francisco, CA (US); Brian Boates, San Rafael, CA (US); Dustin Stolp, San Mateo, CA (US); Meenal Chhabra, Mountain View, CA (US); Scott Cole, San Francisco, CA (US)

(21) Appl. No.: 17/696,168

(22) Filed: Mar. 16, 2022

(51) Int. Cl. G06Q 20/40; G06Q 20/38; G06Q 30/02

(52) U.S. Cl. CPC G06Q 20/4016; G06Q 20/387; G06Q 20/4015; G06Q 30/0225

(57) ABSTRACT

Using a machine learning model(s) for fraud reduction is described. A payment service computing platform may receive, from an electronic device, user data associated with a user, and dynamically determine an incentive(s) associated with the user based on the user data. The incentive(s) may be determined using a trained machine learning model(s) that is trained based on previously collected user data. The payment service computing platform can then cause a user interface to be displayed via a payment application executing on the electronic device, wherein the user interface presents an interactive element(s) for receiving the incentive(s) in exchange for the user referring at least one other user to a payment service.

### TECHNICAL FIELD

Applications, which are downloadable and executable on user devices, enable users to interact with other users. Such applications are provided by service providers and utilize one or more network connections to transmit data among and between user devices to facilitate such interactions.

### BRIEF DESCRIPTION OF THE DRAWINGS

Features of the present disclosure, its nature and various advantages, will be more apparent upon consideration of the following detailed description, taken in conjunction with the accompanying drawings.

FIG. 1 is an example environment for using a machine learning model(s) for fraud reduction, according to an implementation of the present subject matter.

FIG. 2 is an example block diagram illustrating a technique of using a machine learning model(s) for fraud reduction in association with new user account creation, according to an implementation of the present subject matter.

FIG. 3A illustrates example user interfaces contrasting different incentives received by different users of a payment service, according to an implementation of the present subject matter.

FIG. 3B is an example user interface presenting a risk rating associated with a user and an information element to reveal information about actions that the user can take to improve the risk rating.

FIG. 4A illustrates example user interfaces contrasting a first implementation of the present subject matter where an incentive is the same for each contact of a user with a second implementation of the present subject matter where incentives are specific to individual contacts of the user.

FIG. 4B is an example user interface presenting a shared interactive element with which another user may interact to accept an invitation to join the payment service.

FIG. 5 is an example process for using a machine learning model(s) for fraud reduction, according to an implementation of the present subject matter.

FIG. 6 is an example process for incentivizing a user with a dynamically determined incentive, according to an implementation of the present subject matter.

FIG. 7 is an example process for determining a risk metric associated with a user based on additional user data received from an external service(s), according to an implementation of the present subject matter.

FIG. 8 is an example process for determining whether to modify an incentive based on a characteristic(s) of a user, according to an implementation of the present subject matter.

FIG. 9 is an example process for determining whether to modify an incentive(s) associated with a specific contact(s) of a user, according to an implementation of the present subject matter.

FIG. 10 is an example process for determining whether to modify an incentive based on the passage of time and/or additional user data received since determining the incentive, according to an implementation of the present subject matter.

FIG. 11 is an example process for the generation and training of machine learning models to perform one or more of the processes described herein, according to an implementation of the present subject matter.

FIG. 12 is an example environment for performing techniques described herein.

FIG. 13 is an example environment for performing techniques described herein.

FIG. 14 is an example data store used for performing techniques described herein.

FIG. 15 is an example environment for performing techniques described herein.

FIG. 16 is an example block diagram illustrating a system for performing techniques described herein.

In the figures, the left-most digit(s) of a reference number identifies the figure in which the reference number first appears. The use of the same reference numbers in different figures indicates similar or identical items or features. The drawings are not to scale.

### DETAILED DESCRIPTION

Described herein are, among other things, techniques, devices, and systems for using a machine learning model(s) for fraud reduction. In an example, a payment service computing platform may receive, from an electronic device, user data associated with a user. In an example, this user data may include a phone number and/or an email address provided by the user. Additional or alternative data may not be available to the payment service computing platform, for example, when the user is a new user of the payment service who is starting an onboarding process facilitated by the payment service. During the onboarding process, the user may provide a phone number and/or an email address in order to create a new user account with the payment service, but other data may not be available to the payment service computing platform. Even without the user providing any additional information, trained machine learning model(s) can be used to determine a risk metric associated with the user. The risk metric that is determined for a given user may relate to a probability of the user engaging in fraudulent (or non-compliant) behavior (e.g., creating an illegitimate user account) while using the payment service. Based at least in part on the risk metric, the payment service computing platform may dynamically determine an incentive associated with the user. As used herein, “dynamically determining” or “dynamically generating” the incentive means using an automated process (e.g., machine learning) to determine or generate the incentive without user intervention, and in real-time or near real-time. Accordingly, the payment service computing platform may dynamically determine an incentive that is personalized and/or customized for the user at that moment. This means that different users may be assigned different incentives, and that the same user may be assigned different incentives at different instances in time. Such techniques can be used for mitigating or reducing fraudulent use of the payment service.

In an example, a payment application may be serviced by a computing platform associated with a payment service (hereinafter, a “payment service computing platform”). Instances of the payment application execute on electronic devices of users to facilitate transactions and other operations as described herein. In at least one example, the payment application allows for the efficient transfer of funds (e.g., fiat currency, securities (e.g., stocks, bonds, mutual funds), cryptocurrencies, gift cards, etc.) between users of the payment service. Such transfers can be “efficient” in that they can happen electronically, in real-time or near real-time, due to a complex integration of software and hardware components configured to facilitate such transfers.

A service provider of the payment service may provide incentives to users. Incentives may be provided to users for performance of an action(s) or to incentivize performance of an action(s). For example, users may be offered referral incentives in exchange for the users referring other users to the payment service. As another example, users may be offered loyalty incentives in exchange for the users achieving a certain level of usage of the payment service, such as keeping the payment application installed on an electronic device for a certain amount of time, completing an above-threshold number of transactions over a prescribed time period using the payment application, or the like.

In at least one example, incentives can be presented within one or more user interfaces displayed via the payment application. Although the vast majority of users do not engage in fraudulent behavior, there is often a population of users who may try to exploit this type of incentive campaign by fraudulently creating illegitimate user accounts with the payment service solely for the purpose of receiving incentives, with no intention of becoming legitimate users of the payment service. In fact, some users have even deployed software, such as bots, to quickly and cheaply create a large number of illegitimate user accounts for no other purpose than to exploit an incentive campaign of a payment service. Oftentimes this exploitation occurs at a time of onboarding a new user, when the payment service computing platform has little-to-no information about the new user. This makes it difficult to assess whether the new user is a legitimate user who intends to use the payment service as a legitimate user, or whether the new user is a “fraudster” looking for a handout through the creation of an illegitimate user account.

The techniques, devices, and systems described herein train and utilize a machine learning model(s) to mitigate such fraudulent behavior, among other things. For example, user data can be collected by the payment service computing platform as new users are onboarded to the payment service, and as many of those users continue to use the payment service to, among other things, complete transactions using the payment application executing on their electronic devices. Over time, one can appreciate that a large collection of historical user data tied to registered user accounts may be available to the payment service computing platform. The payment service computing platform can then train one or more machine learning models based on a portion of the previously collected user data as a training dataset, whereby the machine learning model(s) can learn to make one or more predictions, such as determining a risk associated with a given user, even with minimal information (e.g., a phone number or an electronic mail (email) address) about the user.

As described above, in an example, the payment service computing platform may receive, from an electronic device, user data associated with a user. In an example, this user data may include a phone number and/or an email address provided by the user. Even without the user providing any additional information, the trained machine learning model(s) can be used to determine a risk metric associated with the user. This is because the trained machine learning model(s) has been trained on a wealth of previously collected user data, and, in some examples, because the payment service computing platform is able to receive additional user data from the user’s electronic device and/or query one or more external services for additional user data about the user. The risk metric that is determined for a given user may relate to a probability of the user engaging in fraudulent (or non-compliant) behavior (e.g., creating an illegitimate user account) while using the payment service. Based at least in part on the risk metric, the payment service computing platform may dynamically determine an incentive associated with the user. Accordingly, the payment service computing platform may dynamically determine an incentive that is personalized and/or customized for the user at that moment. This means that different users may be assigned different incentives, and that the same user may be assigned different incentives at different instances in time. This can mitigate or reduce fraudulent use of the payment service by fraudsters.

In some examples, the incentive(s) can be dynamically determined for the user based at least in part on the user data without determining a risk metric. For example, the incentive(s) may be determined based on analyzing the user data using a trained machine learning model(s). In another example, an additional or alternative metric(s) can be used to dynamically determine incentive(s), and this additional or alternative metric(s) may not account for the risk of fraud. As an example, instead of fraud or risk, the payment service can utilize a metric indicative of an interaction level (e.g., an “interaction” metric) to dynamically determine incentives. For example, users who are likely to interact regularly with the payment service and/or utilize multiple services offered by the payment service may be offered a higher, more valuable incentive than other users who are not likely to interact regularly with the payment service and/or who are likely to utilize fewer services offered by the payment service. As another example, the payment service can utilize a metric indicative of value (e.g., a “value” metric) to dynamically determine incentives. For example, users who are likely to be, or become, “high spenders” (e.g., spend an above-threshold amount) on the payment service and/or invite an above-threshold number of other users to join the payment service may be considered high-value target users, and, therefore, such users may be offered higher, more valuable incentives than other users who are not likely to provide the same or similar value to the payment service.

Moreover, it is to be appreciated that the dynamic determination of an incentive may be value-based and/or time-based. For example, in addition to, or in lieu of, determining a value (e.g., a dollar amount) for the incentive, the payment service computing platform may be configured to dynamically determine a time period for which the incentive is active. In some examples, this time-based incentive determination is based on one or more of the aforementioned metrics (e.g., the risk metric) associated with the user. In an example, a high-risk user may receive an incentive that is active for a relatively short time period (e.g., a day, a few hours, etc.), while a low-risk user may receive an incentive that is active for a relatively long time period (e.g., a week, a month, a year, etc.). In some examples, the value of an incentive can be dynamically modified-increased or decreased-over time, for example, to incentivize or disincentivize use. In some examples, the dynamic determination of an incentive can additionally or alternatively be based on a type of behavior or action the incentive is configured to incentivize, types of interactions or transactions with which an incentive is associated, or the like.

In some examples, the payment service computing platform may be configured to optimize incentives that are offered to users by dynamically determining as high (e.g., value) of an incentive as possible while also mitigating instances of users engaging in fraudulent (or non-compliant) behavior while using the payment service. Accordingly, if the risk metric associated with a first user indicates a high (e.g., greater than or equal to a threshold) risk of fraudulent behavior, the payment service computing platform may be configured to dynamically determine a relatively low incentive for the first user in order to disincentivize the first user from engaging in such fraudulent behavior. By contrast, if the risk metric associated with a second user indicates a low (e.g., less than or equal to a threshold) risk of fraudulent behavior, the payment service computing platform may be configured to dynamically determine a relatively high incentive for the second user in order to incentivize the second user to invite his/her contacts to the payment service.

In conventional techniques, service providers often find it difficult to engage users, and/or keep users engaged, with a payment service. The techniques described herein can drive user engagement and increase retention of engaged users with the payment service. For example, a user may have multiple other users, such as contacts, who they can refer to the payment service computing platform, and the payment service computing platform may be configured to dynamically determine an incentive that is specific to each of those other users. That is, a user may be offered a first incentive in exchange for the user referring a first contact (e.g., a first other user) to the payment service, a second incentive in exchange for the user referring a second contact (e.g., a second other user) to the payment service, and so on and so forth for any number of the user’s contacts. User-specific incentives may help drive user engagement (e.g., by targeting contacts of a user that the user is most likely to interact with, making it more likely for the user to continue to use the payment service and remain engaged with the payment service). At least some of the user’s contacts may be stored in memory of the electronic device of the user and may be accessible to the payment service computing platform upon the user granting the payment service computing platform access to those contacts. Other contacts of the user may be accessed through one or more external services, such as a social network service(s), and the like, which also may obtain authorization from the user before the payment service computing platform can access the user’s social network contacts (e.g., the user’s social network account(s) may be a private account(s)). In some examples, incentives that are specific to the user’s contacts may be based on one or more affinity metrics (e.g., a strength metric, value metric, etc.) associated with the respective contacts. In some examples, a social graph can be used to determine respective affinity metrics associated with the various contacts of the user, the affinity metrics representing respective affinities of the relationships between the user and his/her contacts. For example, an affinity metric may be based on a number and/or frequency of messages sent, and/or phone calls made, between the user and a contact, whether the user has “favorited” a contact, whether the user and a contact are associated on a social network platform (e.g., friends, followers, etc.), or any other suitable indicia of an affinity(ies) between the user and a particular contact of the user. In addition to using affinity metrics to dynamically determine incentives that are specific to the user’s contacts, such affinity metrics can be used to determine a ranked order of the contacts, and the contacts may be presented to the user in the ranked order when a user is referring other users to the payment service.

In some examples, incentives, including those that are specific to the contacts of the user, may be based on one or more characteristics of the individual users. Such characteristics may include a geolocation associated with the user, a type of user (e.g., a high spender), or the like. Such characteristics can be used to create a “network effect” with respect to referring users to the payment service. For example, if the service provider is trying to drive user registration in a particular geographical area (e.g., a new market with low market penetration), users associated with geolocations in that particular geographical area may be associated with relatively higher incentives. For example, an email address of a user’s contact may include the domain “@washington.edu,” indicating a particular geolocation associated with the contact, and if the service provider of the payment service is targeting that geolocation (e.g., a college campus) for user registrations, the relatively high incentive may be associated with the contact based on the geolocation associated with the contact. In another example, the user, and/or one of his/her contacts, may have been a customer of the payment service in the past and may have uninstalled the payment application after conducting a high number of financial transactions and/or financial transactions for relatively high dollar amounts. In this example, the user and/or the contact may be categorized as a “high spender” and may be assigned a relatively high incentive based on the “high spender” categorization.

In some examples, the payment service computing platform may cause a user interface to be displayed via the payment application while the payment application is executing on the user’s electronic device. This user interface may present one or more interactive elements with which the user can interact (e.g., select via user input) to refer another user(s) to the payment service and receive an incentive(s) for doing so. For example, the Interactive element(s) may be selected by the user in order to refer a corresponding contact(s) (e.g., another user(s)) to the payment service. In exchange for the user referring the other user(s) to the payment service, the user may receive a corresponding incentive(s). The user’s interaction with the interactive element(s) may cause an invitation to be sent to the other user(s). The invitation(s) may be sent in various ways, as described herein. In some examples, the user may share an interactive element via an external service(s) (e.g., a social network platform, a gaming platform, email, short message service (SMS) text, etc.) in order to invite another user to join the payment service. Such interactive elements (such as Quick Response (QR) codes, custom uniform resource locators (URLs)) may be customized as the user’s (e.g., as the entity that receives incentives) or payment service’s (e.g., as the entity that generates near real-time incentives) risk acceptance changes. For example, the information embedded in the interactive element can reflect an ever-changing incentive conforming with the risk of the user/payment service, such that when the interactive element is activated, the current incentive value is obtained, which may be different from say a day before, or before the sharing user has performed specific transactions, or interacted with specific merchants.

In some examples, one or more conditions may be associated with an incentive, and those conditions may be monitored for compliance in order to fulfill the incentive. For instance, criteria for fulfilling the incentive may be satisfied when a user(s) complies with the one or more conditions that are associated with the incentive. The one or more conditions may include the other user(s) (e.g., invitee(s)) accepting an invitation(s) (e.g., entering a referral code, clicking on a link, etc.) to register with the payment service, and/or the other user(s) setting up a user account(s) with the payment service, and/or the other user(s) linking a new payment card(s) (e.g., debit card, credit card, stored value card, etc.) or bank account(s) (e.g., configuring a direct deposit) to their payment application, and/or the other user(s) transferring, within a threshold amount of time since accepting the invitation(s), an above-threshold amount of funds to another user using the payment service, and/or the user and/or the other user(s) performing one or more additional actions. Compliance with the one or more conditions may also drive user engagement and/or keep users engaged with the payment service. In some examples, incentives can be nested or otherwise related such that upon satisfaction of a first condition, a first portion of an incentive or a first incentive is awarded, upon satisfaction of a second condition, a second portion of an incentive or a second incentive is awarded, or the like.

Using a machine learning model(s) for fraud reduction allows for, among other things, one or more devices to conserve resources with respect to processing resources, memory resources, networking resources, power resources, etc., in the various ways described herein. For example, by detecting, and selectively disincentivizing, potentially fraudulent users early (e.g., at a time of onboarding, at a time of new user account creation, etc.), fewer users are likely to attempt to exploit an incentive campaign associated with a payment service computing platform. This can, in turn, reduce the number of fraudulent users who are onboarded to the payment service, which, in turn, reduces the number of network transmissions on the payment service computing platform and/or reduces the memory consumed by user data associated with illegitimate user accounts, thereby decreasing contention on the platform and making it more efficient to process transactions for legitimate users of the payment service. As such, techniques described herein offer improvements to existing technical environments.

In addition, the techniques, devices, and systems described herein allow for keeping a valuable incentive campaign intact for legitimate users of a payment service while solving a computer-centric problem of a population of users (either themselves or using bots) exploiting a payment application to create illegitimate user accounts for the sole purpose of receiving an incentive, with no intention of becoming a legitimate customer of the payment service. Such fraudulent behavior is mitigated through the use of a trained machine learning(s) configured to detect, and selectively disincentivize, high-risk users, even when little is known about those users.

In conventional techniques, service providers, such as payment services, often are not able to determine whether a user is legitimate with the minimal user data at the time of onboarding. Therefore, service providers become vulnerable to fraudsters, as described herein. Techniques described herein enable dynamic decisions based on minimal information at onboarding. For example, a trained machine model(s) that has been trained on previously collected user data can be used to dynamically determine an incentive(s) that is personalized for a given user, even when that user provides minimal information (e.g., a phone number or an email address) at a time of onboarding. In some examples, a trained machine learning model(s) is trained to accurately predict a risk metric associated with such a user, and the risk metric, being indicative of the user’s propensity to engage in fraudulent (or non-compliant) behavior while using the payment service, may be used to determine the incentive(s) for the user, which may appropriately incentivize or disincentivize the user, as the case may be. Moreover, by using third-party integrations (e.g., querying one or more external services for additional user data about users), relevant user data can be gathered to quickly assess the risk associated with a user, and do so early in the course of a user engagement (e.g., at the start of onboarding the user).

In some examples, as described above, techniques described herein can be used to convert a high-risk user to a lower risk user, for example, by offering incentive(s) with personalized or customized, actionable recommendation(s) to the high-risk user. Such a “tiered” approach to convert a high-risk user to a lower risk user by customizing their behavior (e.g., channeling them to certain transactions, merchants, etc.) allows the incentives to be modified in near real-time as the risk changes. For example, user interfaces described herein may present risk ratings associated with user, and users may be able to learn about actions that can be performed to improve their risk ratings. For example, a user may improve his/her risk rating if the user completes a specific transaction(s), such as a transaction(s) with a merchant (e.g., a particularly risk-averse merchant), and/or a transaction(s) equal to or greater than a particular value, and/or transactions at a particular frequency (e.g., daily). In this way, the user can “build” a transaction history with the payment service that causes their risk metric (and risk rating) to be modified in near-real time as the user performs the actions, which, in turn, may cause the user’s incentive(s) to be modified in near real-time. In this manner, a high-risk user can be “converted” to a low-risk user by the user performing certain actions, and the payment service computing platform may incentivize this behavior by channeling the user through certain actions (e.g., transactions at certain dollar amounts, transactions with certain merchants, transactions at a certain frequency, etc.).

Moreover, by mitigating fraudulent behavior on the payment service computing platform, fewer illegitimate user accounts are created, and the resulting user experience of legitimate users on the payment service computing platform is improved by fostering an ecosystem of predominantly legitimate users (and fewer illegitimate users). This enhances trust in and security of the payment service computing platform. Further, mitigating fraud using the techniques described herein may, in turn, curb misdirected payments or mitigate instances of legitimate users inadvertently transferring funds to unintended recipients who have fraudulently created illegitimate user accounts on the payment service computing platform. In other words, legitimate users of the payment service can trust that most of the other registered users are also legitimate users of the payment service.

Furthermore, in some examples, the techniques, devices, and systems described herein allow users to promote the payment service by sending invitations between users directly, rather than from the payment service computing platform, which protects the privacy of invitation recipients who are referred by a user because the payment service computing platform is unable to acquire personal information of the invitation recipients until the invitation recipients volunteer to disclose their personal information to the payment service computing platform, after receiving an invitation. As mentioned, in some examples, users may refer other users to the payment service by sharing interactive elements via external services, such as social network platforms, gaming platforms, and the like. In these examples, a sharing user may privately share an interactive element via a direct message environment of a social network platform, for instance, which serves as an invitation to another user to join the payment service. Such private sharing of interactive elements protects the privacy of the invitation recipient whilst enabling an efficient, easy-to-use channel for referring other users to the payment service, especially for invitees who do not already have a payment application installed on their electronic devices.

While several examples presented herein are directed to reducing fraud in the context of a payment service, the techniques described herein are also applicable to other types of services that allow users to register with the service by creating user accounts, and which may have an incentive campaign where users can receive incentives for referring other users to the service. Examples of other types of services besides payment services include electronic commerce (ecommerce) services, social networking services, gaming services, a merchant service, a loyalty program service, a loan service (e.g., capital loan, buy now pay later loan, etc.), a music, podcast and/or video streaming service, or the like. Further, as described above, techniques described herein can be applicable to any type of incentive offering, whether related to referrals or not.

The preceding summary is provided for the purposes of summarizing some example embodiments to provide a basic understanding of aspects of the subj ect matter described herein. Accordingly, the above-described features are merely examples and should not be construed as limiting in any way. Other features, aspects, and advantages of the subject matter described herein will become apparent from the following description of Figures and Claims.

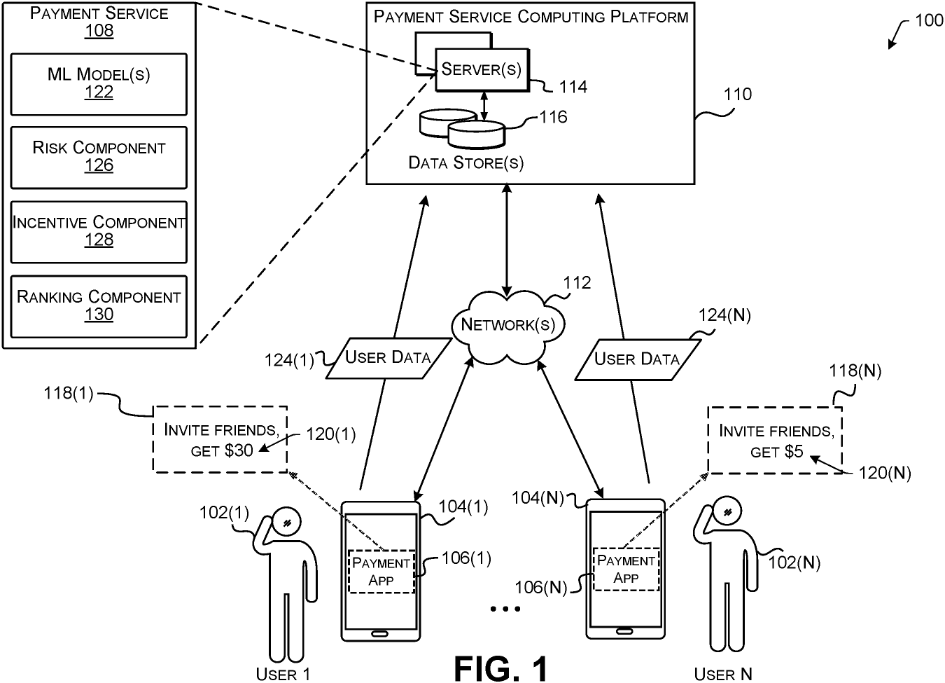

FIG. 1 is an example environment 100 for using a machine learning model(s) for fraud reduction, according to an implementation of the present subject matter. As depicted, the example environment 100 may include users 102(1) to 102(N) (collectively 102, where N is any suitable integer greater than one). Respective users 102 may be associated with respective electronic devices 104(1) to 104(N) (collectively 104), the electronic devices 104 being configured to execute respective applications, e.g., payment applications 106(1) to 106(N) (collectively 106, and interchangeably referred to as payment “app” 106). The payment applications 106, when executing on the respective electronic devices 104, may allow the respective users 102 to navigate to the various user interfaces described herein, to interact with or access services of a payment service 108. In some examples, the respective users 102 can interact with the user interfaces, for example, to facilitate transactions (e.g., electronic payments) with other users, to refer other users to the payment service 108 and, in exchange for doing so, receive associated incentives, among other things. In some examples, the payment application 106 allows two users who are “peers” to transfer funds in a “peer-to-peer (P2P)” transaction. In some examples, the payment application 106 allows a merchant and a customer of the merchant to transfer funds between each other, such as when the customer is purchasing an item(s) from the merchant. In some examples, the payment applications 106(1) to 106(N) can be different instances of a same payment application, which can be provided by a payment service computing platform 110. For example, the users 102 may download and install a particular version of the payment application 106 on their electronic devices 104, either via a first time installation, a software update, or the like.

As depicted by FIG. 1, the respective electronic devices 104 may be coupled to the payment service computing platform 110 via one or more network(s) 112, such as a wide area network (WAN) (e.g., the Internet, a cellular network, etc.). In some examples, the payment service computing platform 110 may include a cloud-based computing architecture suitable for hosting and servicing the respective payment applications 106 executing on the respective electronic devices 104. In particular examples, the payment service computing platform 110 may include a Platform as a Service (PaaS) architecture, a Software as a Service (SaaS) architecture, and an Infrastructure as a Service (IaaS), Data as a Service (DaaS), Compute as a Service (CaaS), or other similar cloud-based computing architecture (e.g., “X” as a Service (XaaS)). The payment service computing platform 110 may be used to implement the aforementioned payment service 108, as described herein.

A service provider may operate the payment service computing platform 110, which may include one or more processing devices 114, such as one or more servers, and one or more data stores 116. The one or more processing devices 114 (e.g., servers) may be configured to provide processing or computing support for the respective payment applications 106 executing on the respective electronic devices 104. The data stores 116 may include, for example, one or more internal data stores that may be utilized to store data (e.g., user transaction history data, user purchase history data, user attribute data, user credit history data, user asset profile data, user contextual data, user interaction data, user preference data, and so forth) associated with the respective users 102.

In particular examples, the one or more data stores 116 may be configured to store one or more data structures designed for recording asset ownership for various users 102. As an example and not by way of limitation, the data store(s) 116 may be configured to store one or more ledgers (e.g., internal ledgers, distributed ledgers, etc.) for tracking assets held by the payment service computing platform 110-each such asset being held by the payment service computing platform 110 may be owned in whole or in part by the payment service computing platform 110 itself or in whole or in part by one or more users 102 of the payment service computing platform 110. The ledger(s) may store service balances associated with the payment service computing platform 110 representing quantities of assets held by the payment service computing platform 110. The service balances may include, for example, a fiat currency balance for each of one or more fiat currencies, a securities balance for each of one or more security assets, a cryptocurrency balance for each of one or more cryptocurrencies, other suitable data records, or any combination thereof. The data store(s) 116 may also be configured to store additional ledgers for each of the users 102. The ledger(s) may be stored as part of a user profile or asset profile for each of the users 102.

One or more ledgers may store user balances representing quantities of assets held by the payment service computing platform 110 and owned by one or more users 102. User balances may have similar contents to the service balances. The payment service computing platform 110 may use other data structures suitable for storing information representing ownership of assets. In some examples, user profiles or asset profiles can include ledgers (e.g., cryptocurrency ledgers, fiat currency ledgers, etc.) for any accounts managed by the payment service computing platform 110 on behalf of the users. In some examples, ledgers are logical ledgers, and the actual data can be represented in a single database. A ledger can reflect a credit when an account is funded. An account can be funded by transferring an asset in the form associated with the account from an external account (e.g., transferring a value of cryptocurrency to the payment service and the value is credited as a balance in a cryptocurrency ledger), by purchasing an asset in the form associated with the account from the payment service using an asset in a different form (e.g., buying a value of cryptocurrency from the payment service using a value of fiat currency reflected in a fiat currency ledger, and crediting the value of cryptocurrency in a cryptocurrency ledger), or by conducting a transaction with another user (customer or merchant) of the payment service wherein the account receives an asset. In some examples, the ledger can reflect a debit when assets are withdrawn from the account, for example. An asset(s) may be withdrawn from an account based on an electronic payment between users (a “payment” being a transfer of assets from one user to another user), a purchase or sale of an item, a transfer of an asset from one account to another account, a conversion of an asset from one form to another form, or the like. While in some examples, the present disclosure refers to crediting or debiting a ledger with a value, it can be appreciated that, in some examples, the actual value that is credited or debited may actually be slightly greater or less than the stated value to account for transaction fees or exchange rates.

In some examples, the payment service computing platform 110 may be a hosting and servicing platform for the respective payment applications 106 executing on the respective electronic devices 104. As depicted by FIG. 1, the respective payment applications 106 may each include, for example, respective user interfaces 118(1) to 118(N) (collectively 118) for displaying, among other data, respective incentives 120(1) to 120(N) (collectively 120), and/or information associated with the incentives 120. The incentives 120 are personalized and/or customized for the individual users 102. In some examples, the payment service computing platform 110 may be configured to reduce fraud by dynamically determining different incentives 120 associated with different users 102 using a trained machine learning model(s) 122. In an example, machine learning model(s) 122 may be used for reducing fraud in association with new user account creation with respect to the payment service 108, but it is to be appreciated that the techniques, devices, and systems are equally applicable to existing (registered) users 102 of the payment service 108 who already have user accounts and/or to users of other services. For instance, machine learning model(s) 122 can be used in association with new user account creation with respect to other services (e.g., a service different than the payment service 108, but associated with the payment service 108). In an example, a user is being onboarded to a streaming service associated with the payment service 108, and the user is offered an incentive for referring at least one other user to the payment service 108. In another example, a customer of a merchant that uses the payment service 108 may be offered an incentive for referring at least one other user to the payment service 108. As yet another example, a user 102 who is being onboarded to the payment service 108 may be offered an incentive for referring at least one other user to another service (e.g., a streaming service) that is associated with the payment service 108. Or, as described above, incentives can be offered for driving loyalty or other behaviors associated with the payment service 108.

As depicted in FIG. 1, the payment service computing platform 110 may receive, from the electronic devices 104, user data 124(1) to 124(N) (collectively 124) associated with the users 102. The user data 124 may be received at any suitable time and/or via any suitable software executing on the electronic device 104. For example, the users 102 may input information via the payment application 106, via a webpage, via an instant app (e.g., a portion of an application), or the like. The information provided by the user 102 may cause the user data 124 to be sent by the electronic device 104 to the payment service computing platform 110 over the network(s) 112. In some examples, the user 102 providing information may prompt a download of a full version of the payment application 106. Accordingly, a user’s electronic device 104, in some examples, may not have the payment application 106 installed thereon at a time that the user data 124 is received by the payment service computing platform 110, and the payment application 106 may be installed on the electronic device 104 at a later time (e.g., after the user data 124 is received by the payment service computing platform 110). In other examples, a full version of the payment application 106 is installed on the electronic device 104 prior to the payment service computing platform 110 receiving the user data 124, such as prior to, or during an early stage of, an onboarding process.

The user data 124 may include, among other data, respective phone numbers and/or email addresses of the users 102. For example, during an onboarding process for onboarding the users 102 as new users to the payment service 108, the respective payment applications 106 may prompt the respective users 102 to provide their phone numbers and/or their email addresses as part of the onboarding process to create respective user accounts for the users 102, and the respective users 102 may provide information via user input (e.g., typing on a virtual keyboard, speaking into a microphone of the electronic device 104, etc.) to specify their phone numbers and/or email addresses. In some examples, to minimize friction and improve user interaction with the payment application 106, the onboarding process may request minimal data from an onboarding user. However, because the payment service computing platform 110 does not have access to additional data at the time of onboarding, in conventional technologies, it can be difficult to differentiate between legitimate and illegitimate users.

The payment application 106 may then cause the electronic devices 104 to send the user data 124 to the payment service computing platform 110 over the network(s) 112, where the user data 124 may be processed (e.g., analyzed) and/or stored in the data store(s) 116. In some examples, the user data 124 can include an Internet Protocol (IP) address, a geolocation, a payment card number, a bank account number, a personal name of the user 102, and/or contacts of the user 102. It can be appreciated that some of the example types of user data 124 mentioned herein may be provided by the electronic device 104 itself, without the user 102 providing information corresponding to the user data 124. This may be the case for the IP address, the geolocation of the electronic device 104, and/or the contacts of the user 102. Other types of user data 124 may be based on information provided by the user 102 (e.g., via user input), such as the payment card number, the bank account number, and/or the personal name of the user. Nevertheless, some or all of this information may additionally or alternatively be provided by software (e.g., an operating system (OS)) of the electronic device 104 (e.g., the OS may retrieve a payment card number, a bank account number, a personal name of the user, or the like from memory of the electronic device 104, if such user data was previously stored in the memory).

A phone number may be a sequence of digits assigned to a subscriber of a wireless carrier, and it may include an area code, which is typically a three-digit code in the United States. An email address may include a local-part, followed by the symbol @, followed by a domain, which may be a domain name or an IP address. An example email address is jane.smith@domain.com, where “jane.smith” is the local-part of the email address, and “domain.com” is the domain, and the symbol @ separates the local-part from the domain. An IP address is a numerical label, such as 192.X.X.X that is connected to a computer network that uses IP for communication. The IP address serves two main functions: network interface identification and local addressing. Accordingly, the IP address can be used to determine a geographical location associated with the electronic device 104 and/or the user 102. A geolocation is a geographical location, such as Global Positioning System (GPS) coordinates. A payment card number is an identifier found on, or otherwise associated with, a payment card, such as a credit card, a debit card, a stored-value card, a gift card, or the like. Such cards can be “linked” to an account associated with the cardholder. A bank account number is an identifier of a financial account maintained by a bank or other financial institution in which the financial transactions between the bank and the customer are recorded. The personal name of the user is an identifying word or words by which an individual is known or designated, and may include a given name or first name(s), a sumame(s), and/or a middle name(s). Contacts of the user 102 can include contacts previously stored in memory of the electronic device 104 and/or accessible remotely from a platform of a wireless carrier. Additionally, or alternatively, contacts of the user 102 can include social network contacts, such as friends, followers, colleagues, families, social acquaintances, or the like, which may be found on social media platforms. Additionally, or alternatively, contacts of the user 102 can include other users who have no previous relationship with the user 102, but who interact with an interactive element shared by the user 102 (e.g., via a social media network(s), a gaming platform, etc.). A list of contacts can include personal information (e.g., email addresses, phone numbers, personal websites, company names, physical addresses, etc.) of the contacts.

As mentioned above, the payment service 108 may include one or more machine learning models 122. As depicted in FIG. 1, the payment service 108 may further include a risk component 126, an incentive component 128, and a ranking component 130. These components, and the payment service 108 itself, may represent computer-executable instructions that, when executed by a processor(s) (e.g., a processor(s) of the processing device 114) cause performance of one or more operations described herein. The risk component 126 may determine a risk metric associated a user 102, the incentive component 128 may determine an incentive 120 associated with the user 102, and the ranking component 130 may rank contacts of the user 102. In some examples, one or more of these components may utilize one or more trained machine learning models 122 to perform these tasks.

Machine learning generally involves processing a set of examples (called “training data” or a “training dataset”) in order to train a machine learning model(s). A machine learning model(s) 122, once trained, is a learned mechanism that can receive new data as input and estimate or predict a result as output. For example, a trained machine learning model can comprise a classifier that is tasked with classifying unknown input (e.g., an unknown image) as one of multiple class labels (e.g., labeling the image as a cat or a dog). In some cases, a trained machine learning model is configured to implement a multi-label classification task (e.g., labeling images as “cat,” “dog,” “duck,” “penguin,” and so on). Additionally, or alternatively, a trained machine learning model can be trained to infer a probability, or a set of probabilities, for a classification task based on unknown data received as input. In the context of the risk component 126, the unknown input may be the user data 124 associated with a user 102, and/or a signal(s) that is/are generated based on the user data 124. The trained machine learning model(s) 122 may be tasked with outputting a risk metric (e.g., a value, a score, a binary (risky, not risky) indication, etc.). The risk metric may indicate, or otherwise relate to, a probability of the user 102 being in one of multiple classes. For instance, the risk metric may relate to a probability of the user 102 behaving (or not behaving, as the case may be) in accordance with a particular behavior while using the payment service 108. The particular behavior may be a fraudulent behavior, a non-compliant behavior, an abusive behavior, or the like. For example, the behavior may be a behavior of creating an illegitimate (or fake) user account for the sole purpose of receiving incentives, with no intention of utilizing the payment service 108 as a legitimate customer. In some examples, the risk metric is a variable that is normalized in the range of [0,1]. In some examples, the trained machine learning model(s) 122 may output a set of probabilities (e.g., two probabilities), or metrics relating thereto, where one probability (or metric) relates to the probability of the user 102 behaving in accordance with the particular behavior, and the other probability (or metric) relates to the probability of the user 102 not behaving in accordance with the particular behavior. The risk metric that is output by the trained machine learning model(s) 122 can relate to either of these probabilities in order to guide the determination of the incentive by the incentive component 128. In some examples, the risk metric may indicate a level of trustworthiness of the user 102. In some examples, the risk metric itself represents a confidence (e.g., a probability) of the output. Additionally, or alternatively, the trained machine learning model(s) 122 may be configured to output a confidence metric (e.g., a confidence value, a confidence score, etc.) associated with the primary output result (e.g., prediction) in order to indicate a confidence level of the machine-learned prediction.

The incentive component 128 may be configured to dynamically determine, based at least in part on the risk metric associated with the user 102 (for example, as determined by the risk component 126), an incentive 120 associated with the user 102. In some examples, the incentive component 128 may utilize a trained machine learning model(s) 122 in a similar manner to that described above with respect to the risk component 126. For example, in the context of the incentive component 128, the unknown input may be the risk metric associated with the user 102, and/or a signal(s) that is/are generated based on the risk metric. The trained machine learning model(s) 122 may be tasked with outputting an incentive 120 (e.g., a value, a score, a binary (high incentive, low incentive) indication, etc.). In this manner, the incentive 120 is dynamically determined (e.g., generated) for the particular user 102. Incentives 120 may be provided to users 102 for performance of an action(s) or to incentivize performance of an action(s). For example, users 102 may be offered the aforementioned incentives 120 as referral incentives in exchange for the users 102 referring other users to the payment service 108. As another example, users 102 may be offered loyalty incentives in exchange for the users 102 achieving a certain level of usage of the payment service 108, such as keeping the payment application 106 installed on an electronic device 104 for a certain amount of time, completing an above-threshold number of transactions over a prescribed time period using the payment application 106, or the like. Another example of an incentive is a discount (e.g., a coupon, a rebate, etc.) that is provided to users 102 to incentivize the users 102 to use the payment service 108. Furthermore, the incentive 120 (sometimes referred to herein as a “bounty” or a “reward”) can be any suitable type of incentive including, without limitation, a fiat currency (e.g., a dollar amount), a gift (e.g., a gift card, a non-fungible token (NFT), etc.), a coupon, a discount, loyalty points, a status, a stock, a bond, a mutual fund, an exchange-traded fund (ETF), a cryptocurrency, a NFT, a purchase (e.g., of stock, cryptocurrency, NFT, etc.), or the like. In an example, the incentive 120 may be determined as a dollar amount in United States fiat currency (e.g., $5, $10, $15, $20, $25, $30, etc.). It is to be appreciated that incentives 120 can be determined in any suitable increments, including decimal amounts, such as $22.50. In some cases, the trained machine learning model(s) 120 used by the incentive component 128 is configured to implement a multi-label classification task (e.g., selecting one of a plurality of incentives, such as $5, $10, $15, $20, $25, $30, etc.). Because incentives 120 are offered to the user 102 in exchange for the user 102 inviting another user (e.g., a contact of the user 102) to the payment service 108, the incentive 120, in some examples, may include two or more values, which may be the same value or different values, and wherein a first value is associated with the user 102 and a second value(s) is associated with another user(s) that the user 102 can invite to the payment service 108. For example, a $10/$5 incentive 120 may indicate that the user 102 is to receive $10 and that the invitee (e.g., other user) is to receive $5 in exchange for the user 102 inviting or referring the invitee/other user to the payment service 108. Accordingly, in some examples, the incentive 120 may be determined as a multi-value dollar amount (e.g., $5/$5, $10/$5, $10/$10, $15/$5, etc.). Although the incentive 120 is often described by way of example as a fiat currency, and particularly United States dollar amount, it is to be appreciated that the incentive 120 can take any other suitable form besides fiat currency, such as those described herein.

The ranking component 130 may be configured to rank a plurality of contacts of the user 102 in a ranked order based on any suitable affinity metric (e.g., a strength metric, a value metric, etc.) associated with the different contacts, where the affinity metrics represents affinities of the relationships between the user 102 and his/her contacts. For example, such an affinity metric may be based on a number and/or frequency of messages sent and/or phone calls made between the user 102 and a contact, whether the user 102 has “favorited” a contact, whether the user 102 and a contact are associated on a social network platform (e.g., friends, followers, etc.), or any other suitable indicia of an affinity between the user 102 and a contact. In this way, the user 102 can be provided with a “short list” of contacts that the user 102 can invite to the payment service 108, where the short list of contacts may be those who the user 102 is most likely to invite, or those who may be the most valuable customers of the payment service 108, and/or any combination thereof. In some examples, the ranking component 130 may utilize a trained machine learning model(s) 122 in a similar manner to that described above with respect to the risk component 126. For example, in the context of the ranking component 130, the unknown input to the trained machine learning model(s) 122 may be contact data associated with the contacts of the user, and/or a signal(s) that is/are generated based on the contact data. The trained machine learning model(s) 122 may be tasked with outputting a ranked list (e.g., a N-best list) of the contacts to determine the ranked order of the contacts.

The trained machine learning model(s) 122 used by one or more of the risk component 126, the incentive component 128, and/or the ranking component 130 may represent a single model or an ensemble of base-level machine learning models, and may be implemented as any type of machine learning model. For example, suitable machine learning models 122 for use by the techniques and systems described herein include, without limitation, neural networks (e.g., deep neural networks (DNNs), recurrent neural networks (RNNs), etc.), tree-based models (e.g., eXtreme Gradient Boosting (XGBoost) models), support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), multilayer perceptrons (MLPs), expectation maximization, genetic algorithms, linear regression algorithms, nonlinear regression algorithms, logistic regression-based classification models, or an ensemble thereof. An “ensemble” can comprise a collection of machine learning models 122 whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble.

The training dataset that is used to train the machine learning model 122 may include various types of data, including previously collected user data associated with users 102 of the payment service 108, as will be described in more detail below. In general, a training dataset for machine learning can include two components: features and labels. However, the training dataset used to train the machine learning model(s) 122 may be unlabeled, in some embodiments. Accordingly, the machine learning model(s) 122 may be trainable using any suitable learning technique, such as supervised learning, unsupervised learning, semi-supervised learning, reinforcement learning, and so on. The features included in the training dataset can be represented by a set of features, such as in the form of an n-dimensional feature vector of quantifiable information about an attribute of the training dataset. As part of the training process, weights may be set for machine learning. These weights may apply to a set of features included in the training data, as derived from historical data (e.g., previously collected user data) in the datastore 116. In some embodiments, the weights that are set during the training process may apply to parameters that are internal to the machine learning model(s) (e.g., weights for neurons in a hidden-layer of a neural network). These internal parameters of the machine learning model(s) may or may not map one-to-one with individual input features of the set of features. The weights can indicate the influence that any given feature or parameter has on the output of the trained machine learning model 122.

As described herein, a fraudulent behavior is an example of a type of behavior that can be predicted for a user 102 and used as a basis for determining an incentive 120. In this example, there may be behaviors associated with a user 102 who is planning on creating an illegitimate user account that are unlike behaviors associated with legitimate users. Thus, the machine learning model 122 may learn (from the training dataset) to identify those behavioral patterns so that users 102 who are likely to create illegitimate accounts can be identified with high confidence. In a supervised learning approach, user accounts of users 102 can be labeled to indicate whether a user 102 was caught exploiting an incentive campaign and banned from using the payment service 108 as a consequence. The data in the datastore 116 may include some data associated with users 102 who have been banned from using the payment service 108 as a result of engaging in fraudulent behavior, and some data associated with users 102 who have not been banned from using the payment service 108. For instance, the use of unauthorized third party software to create illegitimate user account may be determined, and, after a rigorous verification process to make sure that this determination is correct, the user 102 associated with the use of the unauthorized software may be banned by flagging the user’s account as “banned” in the datastore 116. Thus, the status of a user account in terms of whether it has been banned, or not banned, can be used as positive, and negative, training examples.

As mentioned above, certain users 102 may try to exploit an incentive campaign by fraudulently creating illegitimate user accounts with the payment service 108 solely for the purpose of receiving incentives, with no intention of becoming legitimate users of the payment service 108. Moreover, it may be difficult to assess whether individual users (e.g., users 102(1) to 102(N)) are legitimate users who intend to use the payment service 108 as legitimate users, or whether they are “fraudsters” looking for a handout through the creation of illegitimate user accounts. In the example of FIG. 1, the first user 102(1) (User 1) has been offered an incentive 120(1) of $30 for inviting other users (e.g., “friends”) to the payment service 108, while the N^{th} user 102(N) (User N) has been offered a different incentive 120(N) of $5 for inviting other users (e.g., “friends”) to the payment service 108. These dynamically determined incentives 120 may be presented in respective user interfaces 118 via the payment applications 106, and the incentives 120 are personalized and/or customized for the respective users 102 for purposes of reducing fraud. That is, in the example of FIG. 1, the risk component 126 may have determined that User N 102(N) is a high risk user, meaning that the probability of User N engaging in fraudulent (or non-compliant) behavior is relatively high, and, therefore, the incentive 120(N) for User N 102(N) is dynamically determined as a relatively low incentive (e.g., $5). By contrast, the incentive 120(1) of $30 that is dynamically determined for User 1 102(1) is a relatively high incentive 120(1), which may be based on the risk component 126 having determined that User 1 is a low risk user (e.g., likely to be a legitimate customer of the payment service 108). Moreover, the dynamic determination of an incentive 120 may be value-based, time-based, behavior- or transaction-based, combinations of the foregoing, or the like, as mentioned above. For example, in addition to, or in lieu of, dynamically determining a value (e.g., a dollar amount) of the incentive 120, the payment service computing platform 110 may be configured to dynamically determine a time period for which the incentive 120 is active (e.g., redeemable, fulfillable, etc.). In some examples, this determination is based on the aforementioned risk metric associated with the user 102. Accordingly, in some examples, the high-risk user 102(N) may receive an incentive 120(N) that is active for a relatively short time period (e.g., a day, a few hours, etc.), while the low-risk user 102(1) may receive an incentive 120(1) that is active for a relatively long time period (e.g., a week, a month, a year, etc.).

In an illustrative example, a new user 102 may wish to register with the payment service 108. To create a new user account, the user 102 may install a payment application 106 associated with the payment service 108 on an electronic device 104, and the user 102 may begin an onboarding process facilitated by the payment service 108. The user 102 may be prompted to input a phone number or an email address to create a new user account, and, upon inputting the phone number or the email address, the payment service computing platform 110 may receive the phone number or the email address as user data 124 associated with the new user 102. By analyzing the received user data 124 using a trained machine learning model(s) 122, the payment service computing platform 110 may determine a risk metric associated with the new user. Based on the risk metric, the payment service computing platform 110 may dynamically generate an incentive 120 associated with the new user 102. Consider an example where the risk metric indicates a high likelihood of the user 102 engaging in fraudulent behavior while using the payment service 108, such as by creating an illegitimate user account solely to receive an incentive 120, with no intention of continuing to use the payment service 108 as a legitimate customer. In this example, the incentive 120 that is dynamically generated for the new user 102 may be a relatively low incentive (e.g., $5, $1, $0, etc.), such as the $5 incentive 120(N) depicted in FIG. 1 for User N. The relatively low incentive 120(N) disincentivizes the new user 102(N) from engaging in fraudulent behavior. On the other hand, if the risk metric indicates a low likelihood of the user 102 engaging in fraudulent behavior while using the payment service 108, then the incentive 120 that is dynamically generated for the new user 102 may be a relatively high incentive (e.g., $30, $40, etc.) to incentivize the new user 102 to invite their contacts to the payment service 108. This may be the case with the $30 incentive 120(1) depicted in FIG. 1 for User 1. This personalized incentive 120 can be displayed to the new user 102 via a user interface 118 of the payment application 106 executing on the user’s device 104, such as by presenting an interactive element(s) for receiving the incentive 120 in exchange for the new user 102 referring at least one other user to the payment service 108. If the new user 102 interacts with the interactive element(s), the payment service computing platform 110 may send an invitation(s) to the other user(s), monitor invitation data indicating acceptances of the invitation(s), and, based on the invitation data and the incentive 120, the payment service computing platform 110 may transfer an amount of funds to a new user account of the new user 102 in fulfillment of the incentive 120, for example, if the criteria for fulfilling the incentive 120 are satisfied. Additional details are provided below.

In some examples, an additional or alternative metric(s) can be used to dynamically determine incentives 120. As an example, instead of fraud or risk, the payment service 108 can utilize a metric indicative of an interaction level (e.g., an “interaction” metric) to dynamically determine incentives 120. For example, users 102 who are likely to interact regularly with the payment service 108 and/or utilize multiple services offered by the payment service 108 may be offered a higher, more valuable incentive than other users 102 who are not likely to interact regularly with the payment service 108 and/or utilize fewer services offered by the payment service 108. As another example, the payment service 108 can utilize a metric indicative of value (e.g., a “value” metric) to dynamically determine incentives 120. For example, users 102 who are likely to be or become “high spenders” (e.g., spend an above-threshold amount) on the payment service 108 and/or invite an above-threshold number of other users to the payment service 108 may provide relatively high value to the payment service 108, and, therefore, may be offered a higher, more valuable incentive than other users 102 who are not likely to provide value to the payment service 108.

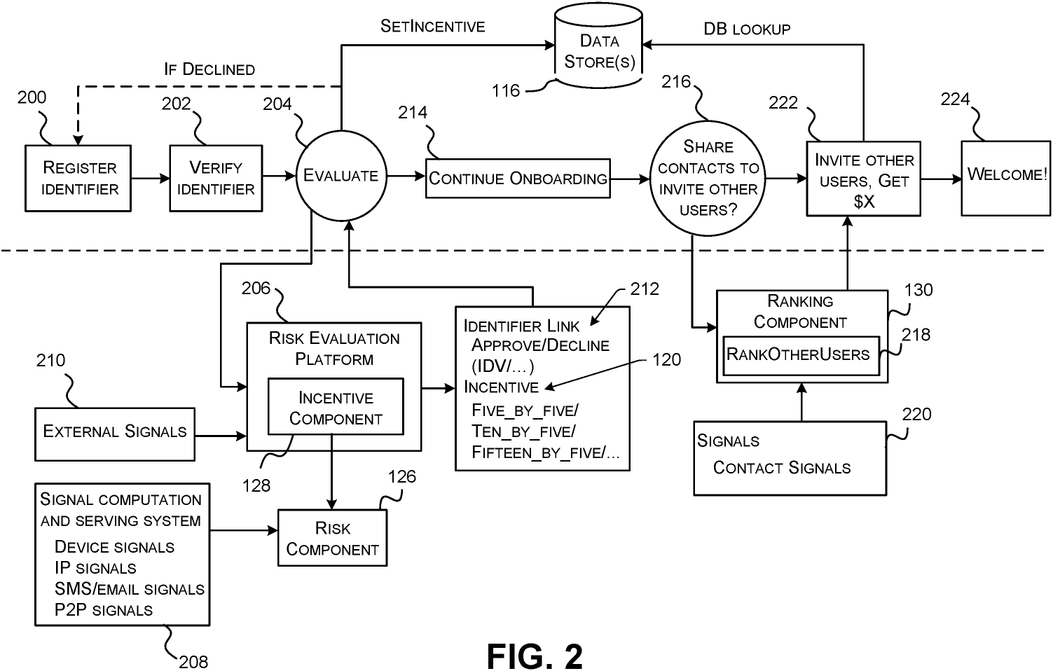

FIG. 2 is an example block diagram illustrating a technique of using a machine learning model(s) 122 for fraud reduction in association with new user account creation, according to an implementation of the present subject matter. The process described with reference to FIG. 2 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. At 200, a user 102 may register an identifier, such as by providing a phone number or an email address. In some examples, the user 102 may, at 200, open the payment application 106 on his/her electronic device 104 and may input the identifier. In some examples, the payment application 106 may prompt the user 102 to input the identifier (e.g., phone number, email, etc.). If the user 102 did not previously install the payment application 106 on the electronic device 104, the user 102 may install the payment application 106 and then open the payment application 106 to register the identifier at 200. In other examples, the user 102 may, at 200, input the identifier via a webpage associated with the payment service 108, via an instant app (e.g., a portion of an application), or the like. Registering the identifier at 200 may cause the electronic device 104 of the user 102 to send the user data 124 to the payment service computing platform 110 over the network(s) 112, as described herein. In some examples, the registering of the identifier at 200 may be performed as part of an onboarding process facilitated by the payment service 108. In this example, the user 102 who is registering the identifier at 200 may represent a new user who is creating a new user account, and whom the payment service computing platform 110 may not have “seen” before the registration of the identifier at 200.

At 202, the identifier may be verified. Verifying the identifier (e.g., phone number, email address, etc.) at 202 may include comparing the identifier to reference data to determine, for example, if a correct syntax was used, and/or it may include querying an external service (e.g., an email hosting service, a wireless carrier, etc.) to confirm that the identifier is valid. In some examples, the verification of the identifier at 202 acts as a preliminary filter to detect when identifiers are input by the user 102 incorrectly and/or to detect and filter out users 102 who otherwise attempt to provide invalid or fake identifiers. In some examples, the verification of the identifier at 202 involves a multi-factor authentication operation(s), such as by texting the user-provided phone number and/or emailing the user-provided email address with a code so for the user 102 to enter via the payment application 106.

At 204, an evaluation operation(s) is performed using user data 124 corresponding to the verified identifier. The evaluation operation(s) at block 204 may include making a call, request, or other data transmission (e.g., a remote procedure call (RPC)) to a risk evaluation platform 206. The risk evaluation platform 206 may include, or otherwise invoke, the risk component 126 described above and elsewhere herein. The risk component 126 is configured to assign risk to the user 102. That is, the risk component 126 is configured to determine, based at least in part on user data 124 associated with the user 102, a risk metric associated with the user 102. In some examples, and as described elsewhere herein, the risk component 126 uses a trained machine learning model(s) 122 to determine the risk metric associated with the user 102. The user data that is used to determine the risk metric associated with the user 102 may include the user-provided identifier (e.g., a phone number, an email address, etc.), and/or additional user data that is obtained from the electronic device 104, and/or additional user data received from an external service(s) based at least in part on the user-provided identifier. FIG. 2 illustrates various signals that can be taken into consideration in assessing the risk associated with the user 102. For example, the risk component 126 may receive, or otherwise generate, one or more “beacon” signals 208. At least some of the beacon signals 208 may be obtained from the electronic device 104 of the user 102. FIG. 2 indicates that the beacon signals 208 can include, without limitation, device signals, IP signals, SMS/email signals, and P2P signals. Notably, because the user 102 being onboarded may be a new user that the payment service computing platform 110 has never encountered before the registration of the identifier at 200, the payment service computing platform 110 may have little-to-no information about the user 102 other than the identifier (e.g., the phone number and/or email address) provided by the user 102 at 200. In other words, the user 102 may not have spent any time, or very little time, using the payment application 106, and the payment service computing platform 110 may not know the types of payments the user 102 will make via the payment service 108, or the like.

Accordingly, user data that is used for the risk assessment of the user 102 may include data about the user’s electronic device 104, such as a device identifier (e.g., a media access control (MAC) address), which can be used to generate device signals, such as whether the user 102 has created an account(s) on this device 104 in the past. An IP address can be used to generate IP signals, such as whether there have been referrals on this IP address in the past. Other IP signals may include whether there has been a sign-up from this IP address in the last hour, day, month, etc. Virtual Private Networks (VPNs) can be determined from data provided by the electronic device 104 to create signals, such as whether the electronic device 104 is connected to a home network or a public network. The identifier (e.g., phone number and/or email address) provided by the user 102 may be used to generate SMS/email signals, such as whether the phone number or email address has been used for fraud in the past, whether the phone number or email address appears in other lists of contacts, and, if so, a number of lists in which it appears. For instance, if the phone number does not appear in any other lists of contacts of other users 102 of the payment service 108, this may be indicative of a high-risk user. In some examples, beacon signals 208 may be generated based on a version of the payment application 106 that is executing on the electronic device 104 of the user 102. For example, a particular version of the payment application 106 with a software “bug” may be exploited by fraudulent users and may be indicative of a high risk user if the exploitable version is known to the payment service computing platform 110, especially if the version of the payment application 106 is an outdated (e.g., a legacy) version of the payment application 106.

FIG. 2 also depicts that the risk evaluation platform 206 (and/or the risk component 126) may receive or otherwise obtain external signals 210. For example, the payment service computing platform 110 may query one or more external services using the user data 124 received from the electronic device 104 of the user 102, such as the user-provided name, mailing address, phone number and/or email address, and may receive, from the external service(s), additional user data about the user 102 that can be analyzed to generate one or more external signals 210 that are used to determine the risk metric associated with the user 102. In some examples, the payment service computing platform 110 may be configured to communicate with one or more external services via one or more networks. In some examples, one or more application programming interfaces (APIs) or other functional components can be used to facilitate such communication. For example, the payment service computing platform 110 may use an API to make a custom call to an external service using the user data 124 associated with a specific user 102. Such an API call can be used to retrieve, from the external service, additional user data that relates to the user data 124, if such additional user data is available. Example external services include email fraud detection services, phone number fraud detection services, loan services, music, podcast, and/or video streaming services, ecommerce services, or the like.

For example, the payment service computing platform 110 can query an email fraud detection service using the user-provided email address, and the external service may return information, such as a risk score associated with the email address, indicating whether the email address has been associated with fraudulent events. This may be particularly useful if the user-provided email address has never been encountered before on the payment service computing platform 110. As another example, the payment service computing 110 can query a phone number fraud detection service using the user-provided phone number, and the external service may return information, such as a risk score associated with the phone number, indicating whether the phone number has been associated with fraudulent events. Even if the user-provided phone number has never been encountered before on the payment service computing platform 110, such an external service may return useful user data indicating that the phone number is a Voice over IP (VoIP) phone number, and/or that the carrier is an international carrier or a domestic carrier, which can be used with machine learning techniques described herein to assess the risk of the user 102. As yet another example, a first- or third-party service (e.g., a loan service, a streaming service, etc.) can be queried to generate external signals 210. Accordingly, if a phone number and/or email address of a user 102 has been encountered on such first- or third-party service, this may provide a useful external signal 210 for assessing risk using machine learning techniques described herein. Other examples of external services that may be queried include social network services, such as Twitter®, Instagram®, Facebook®, or the like. For instance, by querying an external social network service, it may be determined that the user-provided phone number and/or email address is associated with a social network account that has a “blue check mark,” indicating a legitimate user (e.g., the correct person is using the social network account, as opposed to an imposter, or a user with an identity, as opposed to a bot), or a social network account that has interacted with (e.g., followed) the official social network account of the service provider of the payment service 108 on a particular social networking platform(s), and/or a social network account that is following other users on a social networking platform for stock recommendations, etc. Cryptocurrency networks may also be queried to generate external signals 210 for assessing risk of the user 102 using machine learning techniques described herein. For example, by querying an external cryptocurrency network, it may be determined that an IP address associated with the electronic device 104 of the user 102 has interacted with the cryptocurrency network, the date of the interaction, and/or other useful data about the user’s interactions on the cryptocurrency network.

It can be appreciated that a large number (e.g., tens, hundreds, thousands, or the like) of signals 208, 210 can be generated based on user data associated with the user 102, which can be obtained from a brief, initial interaction with the user 102. Because of the potentially large number of signals 208, 210 that can be factored into the risk assessment of the user 102, machine learning is a useful tool to evaluate the multitude of signals 208, 210. Accordingly, the risk component 126 and/or the risk evaluation platform 206 may utilize (e.g., call) a trained machine learning model(s) 122 to determine a risk metric associated with the user 102 based on analyzing the user data 124 associated with the user 102 (e.g., by generating signals 208, 210 and providing the signals 208, 210 as input to the trained machine learning model(s) 122).

With the machine-learned risk metric determined by the risk component 126 and/or the risk evaluation platform 206, the incentive component 128 may dynamically determine (e.g., generate) an incentive 120 associated with the user 102 based on the risk metric, as described herein. For example, the incentive component 128 may utilize one or more rules and/or a trained machine learning model(s) 122 to dynamically determine the incentive 120 based on the risk metric associated with the user 102, as described herein. In addition, the risk evaluation platform 206 may output an approval decision 212 (e.g., approved or declined) regarding the identifier registered at 200 and verified at 202. For example, the risk evaluation platform 206 may determine to decline the registration attempt if it is determined that the user 102 is illegitimate with a high degree of certainty (e.g., a confidence above a threshold), and, in this scenario, the onboarding process may be aborted or terminated, as indicated by the “If Declined” return arrow from 204 to 200. If the risk evaluation platform 206 outputs an approval decision 212 of “approved,” the dynamically determined incentive 120 is stored in the datastore(s) 116 in association with a new user account that has been created for the user 102, as indicated by the “SetIncentive” arrow from 204 to the datastore(s) 116 in FIG. 2.

At 214, after determining and storing the incentive 120 associated with the user 102 in the datastore(s) 116, the onboarding process continues. For example, the user 102 may, at 214, complete a series of steps via the payment application 106, such as by entering a personal name, a user name, a payment card number, a bank account number, a physical address, and/or any other information that may be requested by the payment application 106 and which the user 102 is willing to provide. The user data collected at 214 may also be stored in the datastore(s) 116 in association with the new user account.

At 216, the user 102 may be prompted, via the payment application 106, to share their contacts (e.g., contacts stored on the electronic device 104, social networking contacts, etc.). If the user 102 agrees to share his/her contacts at 216, another call, request, or data transmission (e.g., a RPC) may be made to the ranking component 130, which, at 218, ranks the contacts of the user. In some examples, contact data is used to generate contact signals 220, and the contact signals 220 can be used with a trained machine learning model(s) 122 to output a ranked list (e.g., N-best list) of contacts. As noted above, a list of contacts associated with the user 102 can include personal information (e.g., email addresses, phone numbers, personal websites, company names, physical addresses, etc.) of the contacts. Some or all of this contact data can be used to generate the contact signals 220. In some examples, the ranking component 130 may generate a contact graph and may calculate multi-hop signals. In some examples, the ranking component 130 may transform the graph into a vector representation, which may include data such as lifetime value of a contact, geolocation of a contact, etc. In some examples, external signals similar to the external signals 210 may be generated and used by the ranking component 130 for ranking other users (e.g., contacts of the user 102) at 218. For example, external services (e.g., social network services) may be queried to determine a number of contacts that a user 102 has in common with each of his/her contacts, a domain of an email address(es) associated with a contact, a postal zip code associated with a contact, or the like. These signals can be used to rank the contacts in a ranked order, such as by ranking the contacts in order from “most likely to invite” to “least likely to invite,” or from “high value” to “low value.” In this way, value from the incentive campaign can be optimized through ranking the user’s contacts in a ranked order that may drive user registrations with the payment service 108.

At 222, the incentive 120 can be offered to the user 102 via the payment application 106. For example, a user interface of the payment application 106 may present an offer to invite other users (e.g., “friends”) to receive (e.g., “get”) an incentive 120 (e.g., $X, where X represents any suitable numerical value, such as a dollar amount). The incentive 120 may be looked up in the datastore(s) 116, as indicated by the “DB lookup” arrow from 222 to the datastore(s) 116 in FIG. 2. At 222, the user 102 may interact with one or more interactive elements presented in the user interface of the payment application 106, and such an interaction may initiate a referral of another user(s) to the payment service 108 so that the user 102 can receive the incentive 120. At 224, when the onboarding process is completed, the user interface of the payment application 106 may present a “Welcome!” message, welcoming the user 102 as a new customer of the payment service 108.

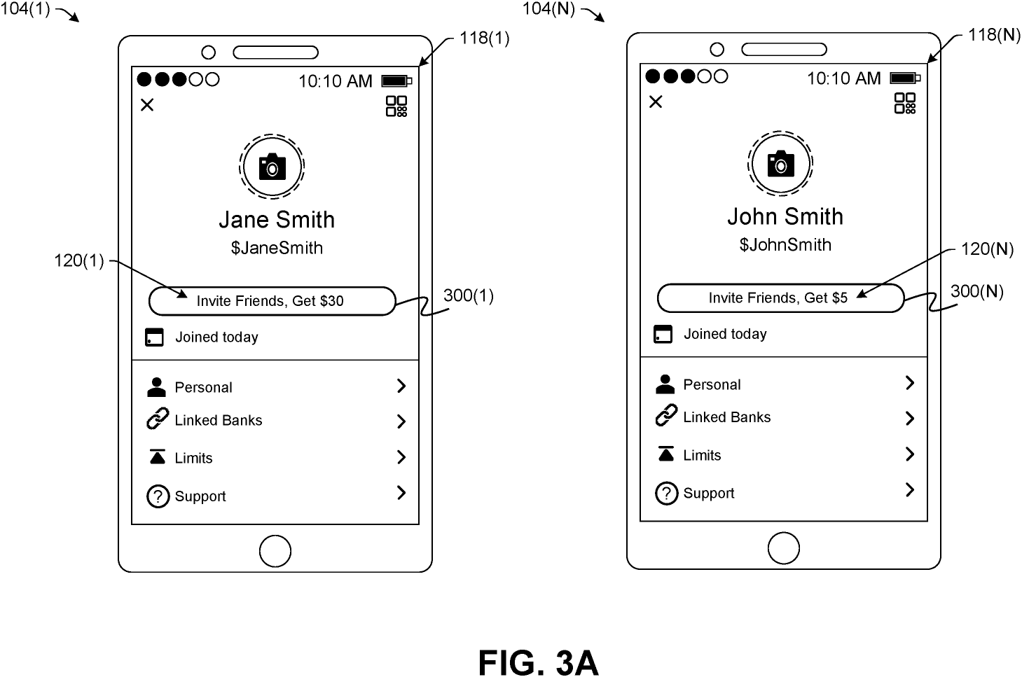

FIG. 3A illustrates example user interfaces 118(1) and 118(N) contrasting different incentives received by different users 102 of a payment service 108, according to an implementation of the present subject matter. The user interfaces 118(1) and 118(N) shown in FIG. 3A may be displayed via the payment application 106 executing on the respective electronic devices 104(1) and 104(N) of the users 102(1) and 102(N) after respective incentives 120(1) and 102(N) have been dynamically determined for the users 102(1) and 102(N). For example, the first user 102(1) (“Jane Smith”) may be presented with the first user interface 118(1), which includes a first incentive 120(1) that says “Invite Friends, Get $30”. This first incentive 120(1) is presented in association with a first interactive element 300(1). The first user 102(1) (“Jane Smith”) may interact with (e.g., select, such as by touching the display) the interactive element 300(1) to invite other users (e.g., contacts) to the payment service 108.

User 102(N) (“John Smith”) may be presented with the second user interface 118(N), which includes a second incentive 120(N) that says “Invite Friends, Get $5”. Accordingly, this second incentive 120(N) is different than the first incentive 120(1) offered to the first user 102(1) (“Jane Smith”). That is, each incentive 120 is personalized and/or customized for the particular user 102. Nevertheless, the second incentive 120(N) is presented in association with a second interactive element 300(N), and user 102(N) (“John Smith”) may interact with (e.g., select, such as by touching the display) the interactive element 300(N) to invite other users (e.g., contacts) to the payment service 108, just like the first user 102(1). If “John Smith” (user 102(N)) plans to create an illegitimate account for the sole purpose of receiving an incentive, with no intention of using the payment service 108 as a legitimate customer, the relatively low incentive 120(N) works to disincentivize user 102(N) from doing so. Meanwhile, the relatively high incentive 120(1) offered to the first user 102(1) may incentivize the first user 102(1) to invite other users (e.g., contacts) to the payment service 108.

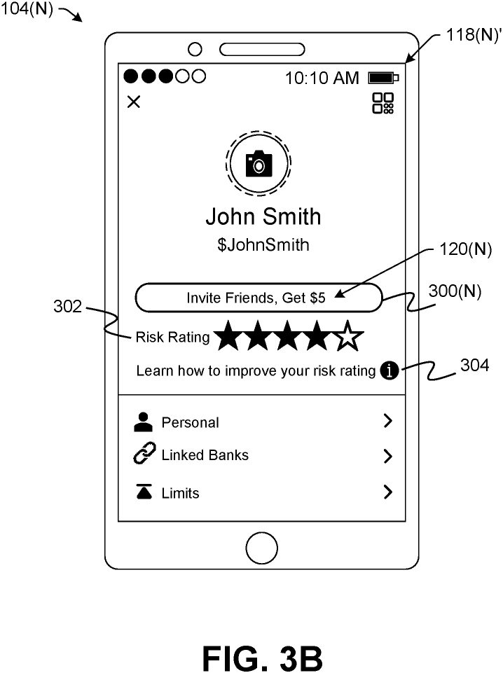

An invitation to another user can be sent in various ways in response to a user interacting with the interactive element(s), such as the interactive elements 300 depicted in FIG. 3A. In one example, interaction, by a user 102, with the interactive element 300 may cause another user interface (e.g., the user interface 400 or 402 depicted in FIG. 4A) to be presented on a display of the electronic device 104. The additional/subsequent user interface (e.g., the user interface 400, the user interface 402, etc.) may present one or more additional interactive elements for inviting individual other users to the payment service 108, as described in more detail below with respect to FIG. 4A.

FIG. 3B is an example user interface 118(N)′ presenting a risk rating associated with a user 102(N) (“John Smith”), as well as an information element 304 that, when selected by the user, reveals information about actions that the user 102(N) can take to improve his/her risk rating 302. As shown in FIG. 3B, the user 102(N) has been assigned a risk rating 302 of four stars out of five stars. The “star” rating scale is merely an example, and other types of rating scales may be implemented. This relatively high risk rating 302 may be based on a relatively high risk metric associated with user 102(N). For example, as described herein, a trained machine learning model(s) 122 may output a relatively high risk metric for the user 102(N), which may relate to a relatively high probability of User N engaging in a particular behavior, such as fraudulent (or non-compliant) behavior, while using the payment service 108. This relatively high risk metric may factor into the relatively low incentive(s) 120(N) that is shown in the user interface 118(N)′ for the user 102(N). In some examples, the risk metric associated with a user 102 (e.g., user 102(N)) can be assumed or balanced with certain actions that the user 102 performs. Accordingly, the user 102 may be able to perform one or more of these actions to lower their risk metric and improve their risk rating 302, which, in turn, may improve (e.g., increase) their incentive 120.

In the example of FIG. 3B, the user interface 118(N)′ presents an information element 304 that the user 102(N) may select in order to reveal information about how they can improve their risk rating 302. In response to selecting the information element 304, the user interface 118(N)′, or another user interface, may present a list of one or more actions that the user 102(N) can perform as suggestions to the user 102(N) to improve their risk rating 302. For example, the information may inform the user 102(N) that his/her risk rating 302 may be improved (e.g., lowered, reduced, etc.) if the user 102(N) completes a specific transaction(s), such as a transaction(s) with a merchant (e.g., a particularly risk-averse merchant), and/or a transaction(s) equal to or greater than a particular value, and/or transactions at a particular frequency (e.g., daily). In some examples, the information element 304 can be “actionable,” such that an interaction with the information element 304 can cause an action to be performed or initiated.

In this way, the user 102(N) can “build” a transaction history with the payment service 108 that causes their risk metric (and the risk rating 302) to be modified in near-real time as the user 102(N) performs the actions, which, in turn, causes the user’s 102(N) incentive(s) 120(N) to be modified in near real-time as the user 102(N) performs the actions. For example, if the user 102(N) were to perform one or more specific transactions, as described above, the user’s 102(N) risk rating 302 may be reduced from four stars to three stars, two stars, or one star, and the user’s 102(N) incentive(s) 120(N) may increase from $5 to $10, $15, or $20, as an illustrative example. In this manner, a high-risk user 102(N) can be “converted” to a low-risk user 102(N) by the user 102(N) performing certain actions to “prove” to the payment service computing platform 110 that they are a legitimate user. The payment service computing platform 110 may incentivize this behavior by channeling the user 102(N) through certain actions (e.g., by channeling the user to complete transactions at certain dollar amounts, transactions with certain merchants, transactions at a certain frequency, etc.).

FIG. 4A illustrates example user interfaces 400 and 402 contrasting different implementations of the present subject matter. In a first implementation, the first user interface 400 may be displayed via the payment application 106(1) executing on the electronic device 104(1) of the first user 102(1). As mentioned above, the first user interface 400 may be displayed in response to the user 102(1) interacting with (e.g., selecting) the interactive element 300(1) presented in the user interface 118(1) of FIG. 3A. The first user interface 400 presents interactive elements 404, 406, 408, and 410. At least some of these interactive elements are for receiving the incentive 120(1) in exchange for the user 102(1) referring respective other users (e.g., contacts of the user 102(1)) to the payment service 108. Although multiple interactive elements 404, 406, 408, and 410 are shown in FIG. 4A, it is to be appreciated that a single interactive element may be presented in the first user interface 400, in some examples, such as when a single contact of the user 102(1) is identified by the payment service computing platform 110. In the example of FIG. 4A, the incentive 120(1) is indicated within each of the interactive elements 404, 408, and 410 as “Get $30,” which indicates to the user 102(1) that by interacting with (e.g., selecting) one of the interactive elements 404, 408, and 410, the user 102(1) can receive the incentive 120. In the first user interface 400, the incentive 120(1) is the same for each contact of a user 102. That is, the user 102(1) is offered an incentive of $30 for referring “Contact A” to the payment service 108, an incentive of $30 for referring “Contact C” to the payment service 108, an incentive of $30 for referring “Contact D” to the payment service 108, and so on for any number of contacts who are not already registered with the payment service 108. As depicted in the first user interface 400, the interactive element 406 includes a check mark to indicate that “Contact B” is already a registered user 102 of the payment service 108. In some examples, the interactive element 406 is not an interactive element, but is a static element that the user 102(1) cannot interact with.

In response to the user 102(1) interacting with one of the interactive elements 404, 408, or 410, an invitation may be sent to another user associated with the interactive element. For example, if the user 102(1) interacts with the interactive element 404, an invitation may be sent over a network(s) (e.g., the network 112) to Contact A. In some examples, the invitation sent to the other user may be a referral code (e.g., a numeric code, an alphanumeric code, a QR code, a barcode, etc.), a link, a deep link, or the like. The invitation can be sent within the payment application 106, in some examples, such as by the payment application 106 causing a notification to be output on the electronic device 104 of the other user. In some examples, the invitation is sent via email, SMS text, or the like. The invitation can be encoded with data to trigger the incentive(s) 120 and/or to streamline onboarding for the user who accepts the invitation. In some examples, the invitation is sent in response to the user 102(1) interacting with (e.g., selecting) the interactive element (e.g., 404) via a single click. In some examples, selection of the interactive element (e.g., 404) may cause a pop-up element to be presented in the user interface 400 for the user 102(1) to copy and paste a link into an email or a SMS text message to the other user.

In some examples, selection of the interactive element (e.g., 404) may allow the user 102(1) to share another interactive element (e.g., a QR code, a link, etc.) via an external service(s) (e.g., a social network platform, a gaming platform, email, SMS text, etc.). For example, selection of an interactive element (e.g., 404) within the user interface 400 may cause a pop-up element to be presented in the user interface 400 with options for the user 102(1) to select for sharing another interactive element via a particular external service(s). In this example, if the user 102(1) selects an option to share the other interactive element via a particular social network platform, the other interactive element may be shared with the other user (e.g., invitee) via the social network platform, such as via a direct message environment of the social network platform. A shared interactive element can be encoded with data to identify the sharing user 102(1) so that the incentive 120 can be fulfilled for the sharing user 102(1) in the event that the invitee (other user) interacts with the shared interactive element to accept the invitation.

FIG. 4B is an example user interface 420 presenting a shared interactive element 422 with which another user (e.g., invitee) may interact to accept an invitation to join the payment service 108. In this example, the user interface 420 represents a user interface of a social network application, which indicates that the sharing user 102(1) has shared the interactive element 422 via an associated social network platform. In the example of FIG. 4B, the user interface 420 is a direct message environment where the sharing user 102(1) and the other user (e.g., invitee) have exchanged private messages in the past. Upon the sharing user 102(1) sharing the interactive element 422 via the social network platform, the shared interactive element 422 may appear in the direct message environment for consumption by the other user, as shown in FIG. 4B. In the example of FIG. 4B, the shared interactive element 422 is in the form of a QR code, but it is to be appreciated that other types of shared interactive elements 422 (e.g., barcodes, links, custom URLs, etc.) can be shared with invitees to refer them to the payment service 108. In the example of FIG. 4B, the user 102(1) also added a personal message 424 to provide the invitee (e.g., Contact A) with additional context (e.g., to explain what the interactive element 422 is for), and/or to provide extra incentive for the invitee (e.g., Contact A) to interact with the shared interactive element 422 in order to accept the invitation from the sharing user 102(1). If the invitee (e.g., Contact A) interacts with the interactive element 422, such as by using a camera application to “scan” the QR code, the invitee may be redirected to the payment application 106 and/or an application store where the payment application 106 can be downloaded to join the payment service 108.

In some examples, the interactive elements described herein (e.g., interactive elements 300, 404, 408, 410, 412, 416, 418, and/or 422) may be customized as the risk acceptance of the user 102(1) (e.g., the entity that receives incentives) changes and/or as the risk acceptance of the payment service 108 (e.g., the entity that generates near real-time incentives) changes. For example, information embedded in the interactive element 422 can reflect an ever-changing incentive conforming with the risk of the user 102(1) and/or the risk of the payment service 108, such that when the interactive element 422 is interacted with, the current incentive value associated with the interactive element 422 is obtained, which may be different from, for example, a day before, or before the sharing user 102(1) has performed specific transactions, or interacted with specific merchants.

With reference again to FIG. 4A, a second implementation is shown where the second user interface 402 may be displayed via the payment application 106(1) executing on the electronic device 104(1) of the first user 102(1). As mentioned above, the second user interface 402 may be displayed in response to the user 102(1) interacting with (e.g., selecting) the interactive element 300(1) presented in the user interface 118(1) of FIG. 3A. The second user interface 402 presents interactive elements 412, 414, 416, and 418. At least some of these interactive elements are for receiving an incentive 120 in exchange for the user 102(1) referring respective other users (e.g., contacts of the user 102(1)) to the payment service 108. Although multiple interactive elements 412, 414, 416, and 418 are shown in FIG. 4A, it is to be appreciated that a single interactive element may be presented in the second user interface 402, in some examples, such as when a single contact of the user 102(1) is identified by the payment service computing platform 110. In the example of FIG. 4A, an incentive 120 is indicated within each of the interactive elements 412, 416, and 418 as “Get $30,” “Get $15,” and “Get $10,” respectively, which indicates to the user 102(1) that by interacting with (e.g., selecting) one of the interactive elements 412, 416, and 418, the user 102(1) can receive an incentive 120. In the second user interface 402, the incentives 120 are specific to each contact of the user 102(1), which means that two or more of the incentives 120 can be different for different contacts of the user 102(1), as depicted in the second user interface 402 of FIG. 4A. That is, the user 102(1) is offered a first incentive of $30 for referring “Contact A” to the payment service 108, an incentive of $15 for referring “Contact C” to the payment service 108, an incentive of $10 for referring “Contact D” to the payment service 108, and so on for any number of contacts who are not already registered with the payment service 108. As depicted in the second user interface 402, the interactive element 414 includes a check mark to indicate that “Contact B” is already a registered user 102 of the payment service 108.

Determining respective incentives 120 that are specific to each contact of the user 102(1) may be performed in various ways. In some examples, user data associated with each unregistered contact of the user 102(1) (e.g., “Contact A,” Contact C,” “Contact D,” etc.) is analyzed using a trained machine learning model(s) 122 to output a risk metric associated with each contact, as described elsewhere herein with reference to the risk component 126. In this example, the risk metric determined for each other user (e.g., each contact of the user 102(1)) may be used to dynamically determine multiple incentives 120, each incentive being specific to a particular contact of the user 102(1), which may help mitigate fraud, as described herein. In some examples, incentives 120 that are specific to the contacts of the user 102(1) may be based on one or more affinity metrics (e.g., a strength metric, value metric, etc.) associated with the respective contacts, which may help drive user engagement and/or improve user retention with the payment service 108, as described herein.

In some examples, a social graph can be used to determine respective affinity metrics associated with the various contacts of the user 102(1), the affinity metrics representing respective affinities of the relationships between the user 102(1) and his/her contacts. For example, such an affinity metric may be based on a number and/or frequency of messages sent and/or phone calls made between the user 102(1) and a contact, whether the user 102 has “favorited” a contact, whether the user 102(1) and a contact are associated on a social network platform (e.g., friends, followers, etc.), or any other suitable indicia of an affinity between the user 102(1) and a contact. Such affinity metrics can be used to determine a ranked order of the contacts and/or whether to associate a relatively high incentive 120 or a relatively low incentive 120 with the specific contact. In some examples, incentives 120 that are specific to the contacts of the user 102(1) may be based on one or more characteristics of the individual contacts, such as a geolocation associated with the contacts, a type of user (e.g., a high spender), or the like. These characteristics may be used to create a “network effect” with respect to referring users 102 to the payment service 108. For example, if the service provider 108 is trying to drive user registration in a particular geographical area (e.g., a new market), contacts associated with geolocations in that particular geographical area may be associated with relatively higher incentives 120. For example, an area code of a phone number of “Contact A” may include a particular sequence of digits (e.g., 2-0-6) and/or an email address of “Contact A” may include the domain “@washington.edu,” indicating a particular geolocation associated with “Contact A,” and if the service provider of the payment service 108 is targeting that geolocation for user registrations, the relatively high incentive of $30 may be associated with “Contact A” based on the geolocation associated with “Contact A.” In another example, “Contact D” may have been a customer of the payment service 108 in the past and may have uninstalled the payment application 108 after conducting very few financial transactions and/or financial transactions for relatively low dollar amounts. In this example, “Contact D” may be categorized as a “low spender” and assigned a relatively low incentive of $10 based on the “low spender” categorization.

As described above with respect to the user interface 402, the user’s 102(1) interaction with one of the interactive elements 412, 416, or 418 may cause an invitation to be sent to another other user associated with the interactive element in any of the ways described herein. For example, if the user 102(1) interacts with the interactive element 416, an invitation may be sent over a network(s) (e.g., the network 112) to Contact C, which is another user who is a contact of the user 102(1).

The processes described herein are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

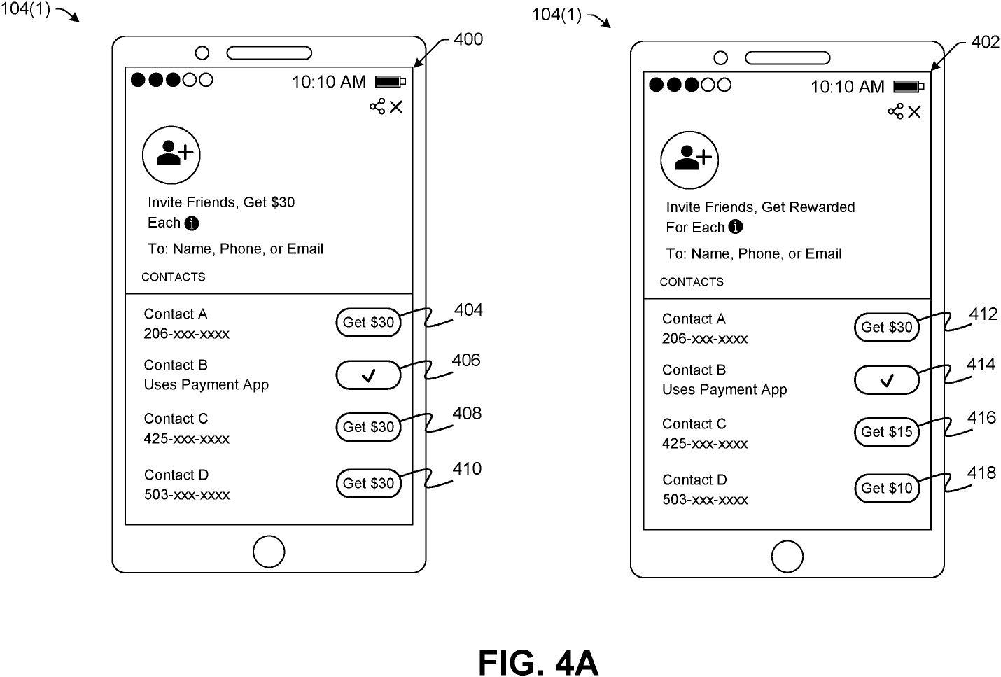

FIG. 5 is an example process 500 for using a machine learning model(s) 122 for fraud reduction, according to an implementation of the present subject matter. The process 500 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 500. The process 500 can be implemented by a system including one or more processors and memory storing computer-executable instructions to cause the one or more processors to perform the process 500. In some examples, the process 500 can be implemented by a processing device(s) 114 (e.g., server(s)) of the payment service computing platform 110. For discussion purposes, the process 500 is described with reference to the previous figures.

At 502, user data 124 associated with a user 102 is received from an electronic device 104. In some examples, a payment service computing platform 110 associated with a payment service 108 (e.g., a processor(s) thereof) may receive the user data 124 at block 502. In some examples. In some examples, the user 102 is a new user with respect to the payment service 108, and the receipt of the user data 124 at block 502 is a result of the new user 102 starting an onboarding process facilitated by the payment service 108 to create a new user account for the user 102. In some examples, prior to block 502, the payment service computing platform 110 has never encountered the user 102 and/or the user data 124 before block 502. In some examples, the user 102 is an existing user of the payment service 108 and already has a user account with the payment service 108. Such a user 102 may have been onboarded in the past (e.g., a day ago, a week ago, a month ago, etc.). In some examples, the payment application 106 may be configured to periodically cause the electronic device 104 to send up-to-date user data 124 associated with the user 102, and the receipt of the user data 124 at block 502 may represent such user data 124 sent after a time interval has lapsed, after new user data 124 is obtained, etc. In some examples, the receipt of the user data 124 at block 502 is a result of the user 102 uninstalling and subsequently reinstalling the payment application 106 on his/her electronic device 104. The user data 124 may be received at block 502 at any suitable time and/or via any suitable software executing on an electronic device 104 of the user 102. For example, the users 102 may input information via the payment application 106, via a webpage, via an instant app (e.g., a portion of an application), or the like. If the user 102 provides information via the payment application 106, the payment service computing platform 110 may receive the user data 124 at block 502 from the electronic device 104 executing the payment application 106. If the user 102 is a new user, the user data 124 received at block 502 may be received during an onboarding process facilitated by the payment service 108 for onboarding the user 102 to the payment service 108. The user data 124 received at block 502 may include one or more of a phone number, an email address, an IP address, a geolocation, a payment card number, a bank account number, a personal name of the user 102, and/or contacts of the user 102.

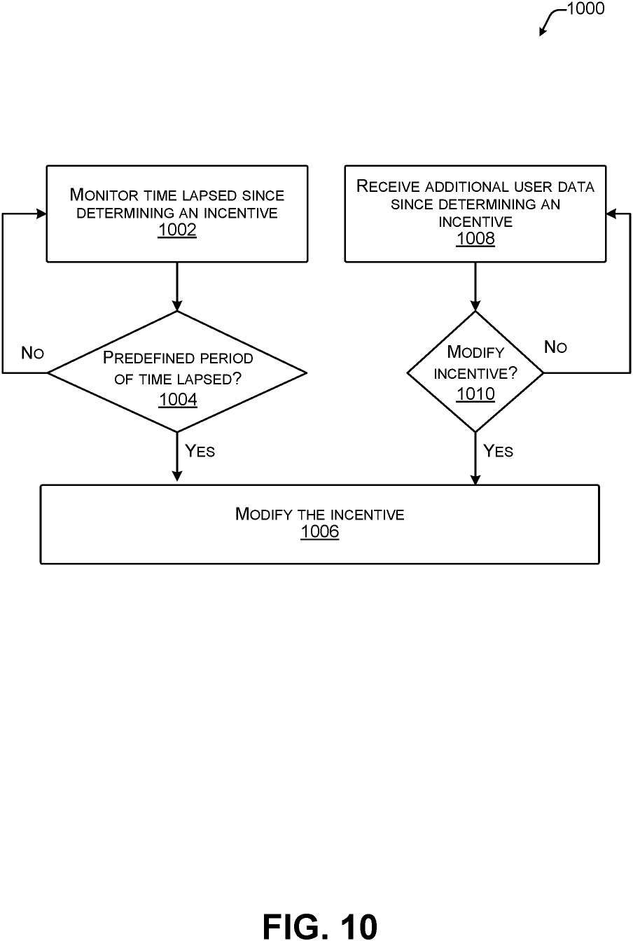

At 504, a risk metric associated with the user 102 is determined based at least in part on the user data 124 received at block 502. In some examples, the payment service computing platform 110 may determine the risk metric at block 504. At 506, in some examples, a trained machine learning model(s) 122 is used to determine the risk metric. For example, the risk metric may be determined based on analyzing the user data 124 using a trained machine learning model(s) 122. The trained machine learning model(s) 122 used at block 506 may have been trained based on previously collected user data, such as user data associated with newly created user accounts, is described in more detail elsewhere herein (e.g., FIG. 10). The risk metric determined at block 504 may be a value, a score, a binary (risky, not risky) indication, or the like. In some examples, the risk metric determined at block 504 may be associated with a confidence metric. The risk metric determined at block 504 may indicate, or otherwise relate to, a probability of the user 102 being in one of multiple classes. For instance, the risk metric may relate to a probability of the user 102 behaving (or not behaving, as the case may be) in accordance with a particular behavior while using the payment service 108. The particular behavior may be a fraudulent behavior, a non-compliant behavior, an abusive behavior, or the like. For example, the behavior may be a behavior of creating an illegitimate (or fake) user account for the sole purpose of receiving incentives, with no intention of utilizing the payment service 108 as a legitimate customer.

At 508, an incentive(s) 120 associated with the user 102 is dynamically determined based at least in part on the risk metric determined at block 504. In some examples, the payment service computing platform 110 may dynamically determine (e.g., generate) the incentive(s) 120 at block 508. At 510, in some examples, a trained machine learning model(s) 122 is used to determine the incentive(s) 122. For example, the incentive(s) 120 may be determined based on analyzing the risk metric using a trained machine learning model(s) 122. In some examples, the trained machine learning model(s) 122 used at block 506 is a first trained machine learning model(s) 122 and the trained machine learning model(s) 122 used at block 510 is a second trained machine learning model(s) 122 (e.g., multiple different trained machine learning models 122 may be used in the process 500). The incentive(s) 120 (e.g., bounty, reward, etc.) determined at block 508 can be any suitable type of incentive including, without limitation, a fiat currency (e.g., a dollar amount), a gift (e.g., a gift card, a NFT, etc.), a coupon, a discount, loyalty points, a status, a stock, a bond, a mutual fund, an ETF, a cryptocurrency, a NFT, a purchase (e.g., of stock, cryptocurrency, NFT, etc.), or the like.

At 512, a determination may be made as to whether the risk metric determined at block 504 is a high risk metric (or a low risk metric, as the case may be), such as by determining whether the risk metric satisfies a threshold. Satisfying a threshold may include meeting or exceeding the threshold, or strictly exceeding the threshold. For example, if the risk metric is a variable that is normalized in the range of [0,1], the risk metric may be determined to be a “high” risk metric at block 512 if the risk metric is equal to or greater than 0.8. If the risk metric is determined as a “high” risk metric, the process 500 may follow the YES route from block 512 to block 514A. At 514A, the incentive(s) 120 may be determined as an incentive (e.g., a dollar amount) that is relatively low (e.g., equal to or less than a threshold value) to disincentivize the “high risk” user 102 from engaging in fraudulent behavior while using the payment service 108. On the other hand, if the risk metric is not determined as a “high” risk metric, the process 500 may follow the NO route from block 512 to block 514B. At 514B, the incentive(s) 120 may be determined as an incentive (e.g., a dollar amount) that is relatively high (e.g., equal to or greater than a threshold value) to incentivize the “low risk” user 102 to refer or invite his/her contacts to the payment service 108. Accordingly, in at least some examples, the determination of the incentive(s) 120 at block 508 can be at least partially a rule-based determination (e.g., based on comparing the risk metric to a threshold). Additionally, or alternatively, a trained machine learning model(s) 122 can be used at block 510 to determine the incentive(s) 120.

It is to be appreciated that, in some examples, blocks 504 and 506 may be omitted from the process 500. In these examples, the incentive(s) 120 may be dynamically determined at block 508 based at least in part on the user data 124 received at block 502, and, in some examples, the incentive(s) 120 may be determined based on analyzing the user data 124 using a trained machine learning model(s) 122. In some examples, an additional or alternative metric(s) can be used in addition to, or in lieu of, the aforementioned risk metric to dynamically determine an incentive(s) 120 at block 508. As an example, instead of fraud or risk, the payment service 108 can utilize a metric indicative of an interaction level (e.g., an “interaction” metric) to dynamically determine an incentive(s) 120 at block 508. For example, if the user 102 is likely to interact regularly with the payment service 108 and/or utilize multiple services offered by the payment service 108, the user 102 may be offered a higher, more valuable incentive(s) 120 than other users who are not likely to interact regularly with the payment service 108 and/or utilize fewer services offered by the payment service 108. As another example, the payment service 108 can utilize a metric indicative of value (e.g., a “value” metric) to dynamically determine an incentive(s) 120 at block 508. For example, if the user 102 is likely to be or become a “high spender” (e.g., spend an above-threshold amount) on the payment service and/or invite an above-threshold number of other users to the payment service 108, the user 102 may be offered a higher, more valuable incentive 120 than other users who are not likely to provide value to the payment service 108. Moreover, the dynamic determination of an incentive 120 at block 508 may be value-based and/or time-based. For example, in addition to, or in lieu of, dynamically determining a value (e.g., a dollar amount) of the incentive 120, the payment service computing platform 110 may be configured to dynamically determine, at block 508, a time period for which the incentive 120 is active (e.g., redeemable). In some examples, this determination is based on the aforementioned risk metric associated with the user 102. Accordingly, in some examples, the high-risk user 102(N) in the example of FIG. 1 may receive an incentive 120(N) that is active for a relatively short time period (e.g., a day, a few hours, etc.), while the low-risk user 102(1) in the example of FIG. 1 may receive an incentive 120(1) that is active for a relatively long time period (e.g., a week, a month, a year, etc.).

At 516, a user interface is caused to be displayed via the payment application 106 executing on the electronic device 104 associated with the user 102, the user interface presenting an interactive element(s) for receiving the incentive in exchange for the user 102 referring at least one other user to a payment service 108. In some examples, the payment service computing platform 110 may cause the user interface to be displayed at block 516. Examples of the user interface that can be displayed at block 516 include the user interfaces 118, 400, and 402, as described above with reference to FIGS. 1, 3A, 3B, and 4A.

At 518, a list of contacts associated with the user 102 is accessed. In some examples, the payment service computing platform 110 may access the list of contacts at block 518. In some examples, the list of contacts may be stored in memory of the electronic device 104 of the user 102, and such a list may be accessed by the payment service computing platform 110 in response to the user 102 providing user input via the payment application 106 to “share” his/her contacts. That is, the payment service computing platform 110 may receive contact data from the electronic device 104 of the user 102, the contact data associated with contacts stored on the electronic device 104. In some examples, the list of contacts is accessed at block 518 via third party social network services (e.g., social network contacts/friends of the user 102). In some examples, the other users associated with the interactive element(s) presented in the user interface at block 516 correspond to at least some of the contacts in the list of contacts.

At 520, contacts in the list of contacts are ranked in a ranked order. In some examples, the payment service computing platform 110 may rank the contacts at block 520. At 522, in some examples, a trained machine learning model(s) 122 (e.g., a third trained machine learning model(s) 122, in the process 500) may be used to rank the contacts. For example, the contacts may be ranked based on analyzing contact data using a trained machine learning model(s) 122 to determine a ranked list (e.g., an N-best list) of the contacts. A plurality of contacts of the user 102 may be ranked at block 520 based on any suitable affinity metric (e.g., a strength metric, a value metric, etc.) associated with the different contacts, as described herein.

At 524, the interactive element(s) associated with the other users (e.g., contacts) that the user 102 can refer to the payment service 108 may be presented in the ranked order. That is, the interactive elements (e.g., the interactive elements 404, 408, and 410 in the user interface 400 of FIG. 4A) may be positioned in the user interface based on the ranked order. Accordingly, at 524, a first interactive element (e.g., interactive element 404) associated with a first other user (e.g., contact) may be positioned above a second interactive element (e.g., interactive element 408) associated with a second other user (e.g., contact), and each interactive element can be interacted with (e.g., selected) by the user 102 to receive the incentive 120 in exchange for the new user referring the corresponding user (e.g., contact) to the payment service 108. In this way, the user 102 can be provided with a “short list” of contacts that the user 102 can invite to the payment service 108, where the short list of contacts may be those who the user 102 is most likely to invite, or those who may be the most valuable customers of the payment service 108, and/or any combination thereof.

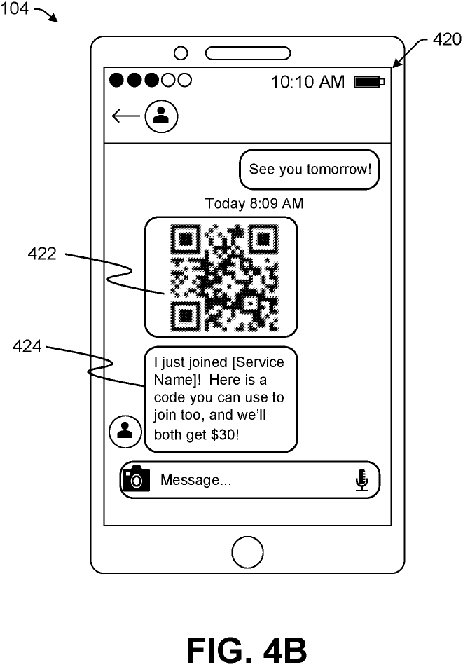

FIG. 6 is an example process 600 for incentivizing a user 102 with a dynamically determined incentive(s) 120, according to an implementation of the present subject matter. The process 600 can be implemented by a system including one or more processors and memory storing computer-executable instructions to cause the one or more processors to perform the process 600. In some examples, the process 600 can be implemented by a processing device(s) 114 (e.g., server(s)) of the payment service computing platform 110. In some examples, the process 600 continues from block 516 or block 524 of the process 500. For discussion purposes, the process 600 is described with reference to the previous figures.

At 602, referral data indicating interactions with interactive elements for referring users is monitored in real-time or near-real-time. In some examples, the payment service computing platform 110 may monitor the referral data at block 602, and the referral data that is monitored may be stored in the datastore(s) 116. In an example, the user interface displayed at block 516 of the process 500 may present one or more interactive elements (e.g., interactive elements 404, 408, and 410 presented in the user interface 400), and the referral data may be generated based on the user 102 interacting with one or more of those presented interactive elements. In some examples, the referral data is monitored at block 602 in real-time or near real-time.

At 604, based on the referral data, a determination as to whether the user 102 is requesting to refer another user(s) is made. If it is determined, based on the referral data, that the user 102 has not interacted with any of the interactive elements indicating that the user 102 is not requesting to refer another user(s) to the payment service 108, the process 600 may follow the NO route from block 604 to block 602 where the payment service computing platform 110 continues to monitor the referral data. If it is determined, based on the referral data, that the user has interacted with (e.g., selected) an interactive element(s) presented in the user interface (e.g., the user interface 400) indicating that the user 102 is requesting to refer another user(s) to the payment service 108, the process 600 may follow the YES route from block 604 to block 606.

At 606, in response to an interaction with the interactive element(s), an invitation(s) is/are sent to the other user(s). In some examples, the payment service computing platform 110 may send the invitation(s) at block 606, such as by sending the invitations over the network(s) 112 to the other user(s)′ electronic device(s) 104. In some examples, the invitation(s) sent at block 606 may be referral code (e.g., a numeric code, an alphanumeric code, a QR code, a barcode, etc.), a link, a deep link, or the like. The invitation(s) can be sent within the payment application 106, in some examples, such as by the payment application 106 causing a notification to be output on the electronic device(s) 104 of the other users. In some examples, the invitation(s) is/are sent at block 606 via email, text, or the like. The invitation(s) sent at block 606 can be encoded with data to trigger the incentive(s) 120 and/or to streamline onboarding for the user(s) who accepts the invitation(s).

At 608, invitation data indicating acceptances of one or more invitations sent at block 606 is monitored, in real-time or near-real-time. In some examples, the payment service computing platform 110 may monitor the invitation data at block 608, and the invitation data that is monitored may be stored in the datastore(s) 116. In some examples, the monitoring of the invitation data may include determining whether the other user(s) has/have entered a referral code sent as part of the invitation(s). In some examples, the invitation data is monitored at block 608 in real-time or near real-time

At 610, based on the invitation data, a determination as to whether the other user(s) has/have accepted the invitation(s) is made. If it is determined, based on the invitation data, that the other user(s) has/have not accepted the invitation(s), the process 600 may follow the NO route from block 610 to block 608 where the payment service computing platform 110 continues to monitor the invitation data. If it is determined, based on the invitation data, that the other user(s) has/have accepted the invitation(s), the process 600 may follow the YES route from block 610 to block 612.

At 612, a determination as to whether criteria are met (or satisfied) is made. For example, criteria for fulfilling the incentive(s) may be met/satisfied at block 612 when the other user(s) accepts an invitation(s) (e.g., enters a referral code, clicks on a link, etc.) to register with the payment service 108, and/or when the other user(s) sets up a user account with the payment service 108, and/or when the other user(s) links a new payment card (e.g., debit card, credit card, stored value card, etc.) or bank account (e.g., configures a direct deposit) to their payment application 106, and/or when the other user(s) transfers an above-threshold amount of funds to another user using the payment service within a threshold amount of time (e.g., 14 days) since accepting the invitation(s), and/or the user 102 and/or the other user(s) performing one or more actions, and/or other criteria. If it is determined that the criteria are not met/satisfied, the process 600 may follow the NO route from block 612 to continue monitoring for the criteria being met/satisfied at block 612. If it is determined that the criteria are met/satisfied, the process 600 may follow the YES route from block 612 to block 614.

At 614, an amount of funds based on the incentive(s) 120 is determined and transferred from a payment service account of the payment service 108 to the user 102 in fulfilment of the incentive(s). In some examples, the payment service computing platform 110 may transfer the funds at block 614.

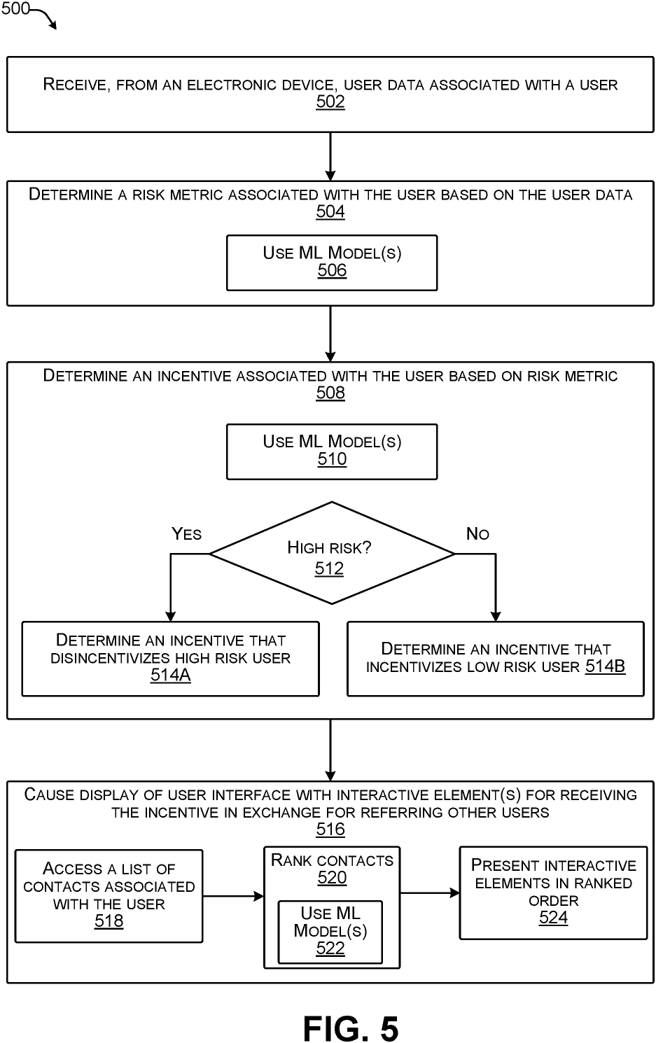

FIG. 7 is an example process 700 for determining a risk metric associated with a user 102 based on additional user data received from an external service(s), according to an implementation of the present subject matter. The process 700 can be implemented by a system including one or more processors and memory storing computer-executable instructions to cause the one or more processors to perform the process 700. In some examples, the process 700 can be implemented by a processing device(s) 114 (e.g., server(s)) of the payment service computing platform 110. In some examples, the process 700 is a sub-process of block 504 of the process 500. For discussion purposes, the process 700 is described with reference to the previous figures.

At 702, an external service(s) is queried using user data 124 received from an electronic device 104 of a user 102. In some examples, the payment service computing platform 110 may query the external service(s) using the user data 124 at block 702. Example external services include email fraud detection services, phone number fraud detection services, loan services, music, podcast, and/or video streaming services, ecommerce services, or the like, as described herein.

At 704, additional user data associated with the user 102 is received from the external service(s). In some examples, the payment service computing platform 110 may receive the user data 124 at block 704.

At 706, a risk metric associated with the user 102 is determined. In some examples, the payment service computing platform 110 may determine the risk metric at block 706. At 708, in some examples, a trained machine learning model(s) 122 is used to determine the risk metric. For example, the risk metric may be determined based on analyzing the additional user data received from the external service(s) using the trained machine learning model(s) 122. As mentioned, the process 700 may be a sub-process of block 504 of the process 500, and, as such, the risk metric determined at block 706 may correspond to the risk metric determined at block 504 of the process 500.

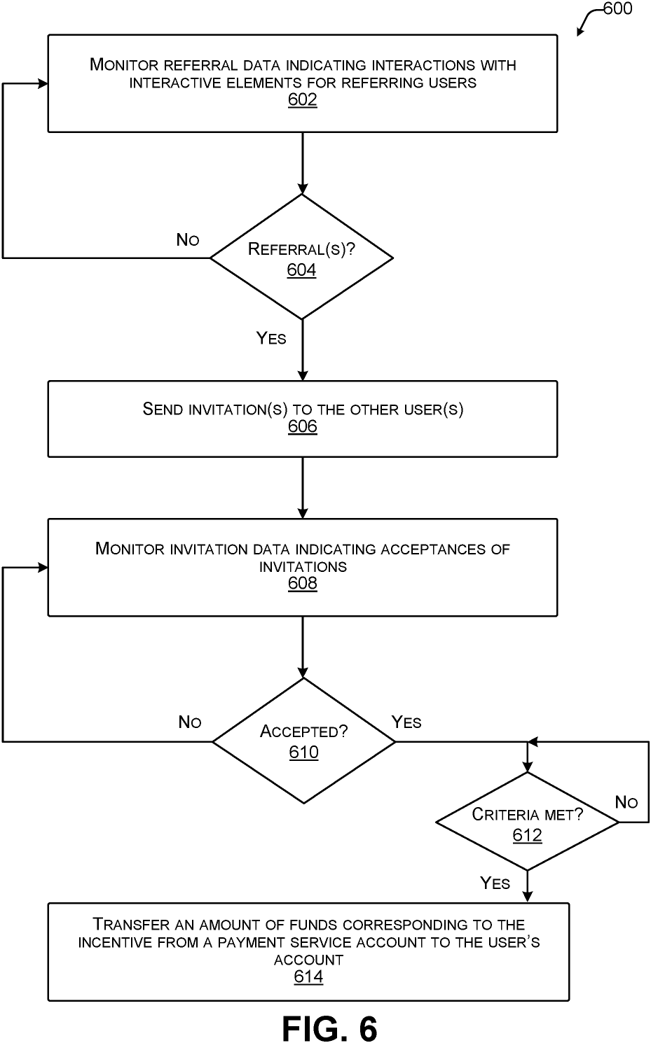

FIG. 8 is an example process 800 for determining whether to modify an incentive based on a characteristic(s) of a user, according to an implementation of the present subject matter. The process 800 can be implemented by a system including one or more processors and memory storing computer-executable instructions to cause the one or more processors to perform the process 800. In some examples, the process 800 can be implemented by a processing device(s) 114 (e.g., server(s)) of the payment service computing platform 110. In some examples, the process 800 is a sub-process of block 508 of the process 500. For discussion purposes, the process 800 is described with reference to the previous figures.

At 802, a characteristic(s) associated with a user 102 is determined based at least in part on user data 124 received from an electronic device 104 of the user 102. In some examples, the payment service computing platform 110 may determine the characteristic(s) at block 802. The characteristic(s) determined at block 802 may include one or more of a geolocation, a classification (e.g., a spending limit, such as a high spender, a frequent user of the payment service 108, lifetime value, etc.), a number of existing contacts of the user 102 that are already registered users of the payment service 108, and/or an affiliation with an entity (e.g., a university, a neighborhood, etc.). The characteristic(s) determined at block 802 may be indicative of a network affinity associated with the user 102, which may be factored into the determination of an incentive(s) 120 for the user 102.

At 804, a determination is made as to whether to modify an incentive(s) 120 associated with the user 102 based on the characteristic(s). For example, geolocation may be a factor in determining the incentive 120, such as to target a particular geographical area to accelerate growth of (e.g., increase user registrations with) the payment service 108. Targeting geolocation can be on any suitable level (e.g., country level, state level, county level, city level, neighborhood level, etc.). As another example, if a high number of the user’s contacts are already registered users of the payment service 108, the user 102 may be inclined to use the payment service 108 more than a user with fewer contacts on the payment service, which may result in increasing the incentive 120 to incentivize the user 102 to invite even more contacts to the payment service 108. If it is determined to modify the incentive 120, the process 800 may follow the YES route from block 804 to block 806.

At 806, the incentive 120 associated with the user 102 may be modified based at least in part on the characteristic(s) determined at block 802. For example, the incentive 120 may be increased if the geolocation of the user 102 is within a geographical area that is being targeted for growth. As mentioned, the process 800 may be a sub-process of block 508 of the process 500, and, as such, modifying the incentive(s) 120 at block 806 may be performed as part of the dynamic determination of the incentive(s) 120 at block 508 of the process 500. In other words, in some examples, the characteristic(s) determined at block 802 is considered for dynamically determining the incentive(s) 120 associated with the user 102.

If it is determined to refrain from modifying the incentive(s) 120, the process 800 may follow the NO route from block 804 to block 808, where the payment service computing platform 110 refrains from modifying the incentive(s) 120. For example, if the geolocation of the user 102 is within a saturated market that is not being targeted for growth, the characteristic(s) may not be factored into the amount of the incentive(s) 120, in some examples.

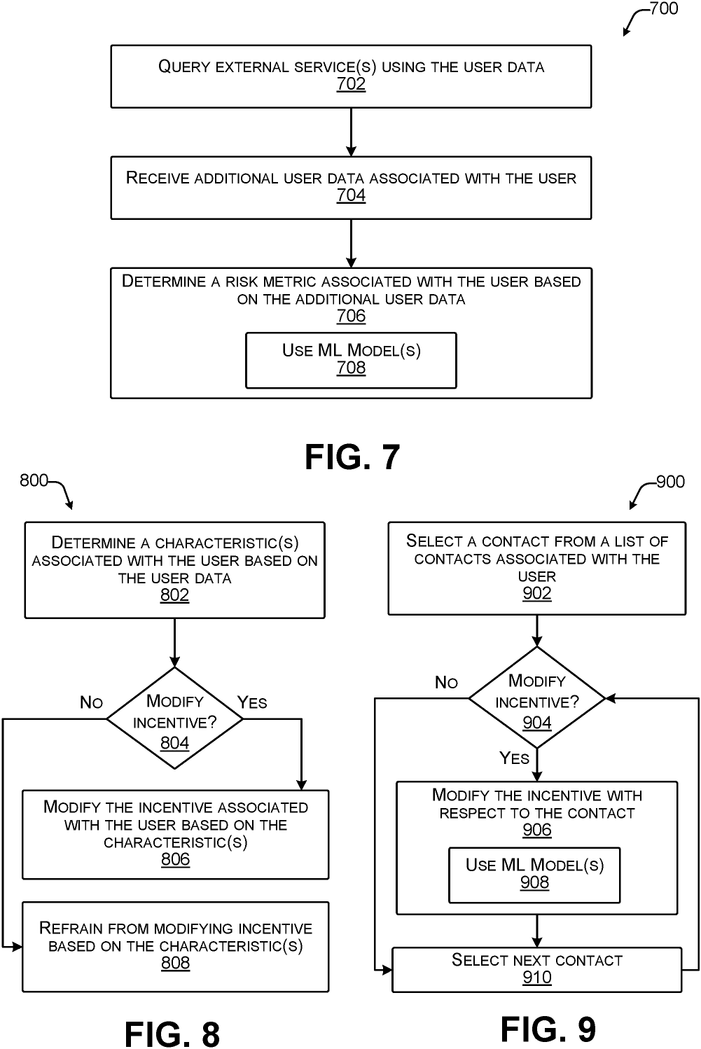

FIG. 9 is an example process 900 for determining whether to modify an incentive(s) 120 associated with a specific contact(s) of a user 102, according to an implementation of the present subject matter. The process 900 can be implemented by a system including one or more processors and memory storing computer-executable instructions to cause the one or more processors to perform the process 900. In some examples, the process 900 can be implemented by a processing device(s) 114 (e.g., server(s)) of the payment service computing platform 110. In some examples, the process 900 is a sub-process of block 508 of the process 500. For discussion purposes, the process 900 is described with reference to the previous figures.

At 902, a contact from a list of contacts associated with a user 102 is selected. For example, a first contact in a list of contacts stored on the electronic device 104 of the user 102 may be selected at block 902. In some examples, the list of contacts includes contacts from a third party social network service. In some examples, the payment service computing platform 110 may select the contact at block 902.

At 904, a determination is made as to whether to modify an incentive(s) 120 associated with the selected contact and the user 102. This determination may be based on an affinity metric, as described herein, such as an affinity metric determined from a social graph associated with the user 102. For example, if an affinity metric (e.g., a strength metric, value metric, etc.) associated with the selected contact satisfies a threshold, a determination may be made to modify the incentive(s) 120 associated with the selected contact and the user 102. If it is determined to modify the incentive 120, the process 900 may follow the YES route from block 904 to block 906.

At 906, the incentive 120 associated with the selected contact and the user 102 may be modified. In some examples, the incentive 120 may be modified based on the affinity metric associated with the selected contact. For example, the incentive 120 may be increased if the affinity metric satisfies (e.g., is equal to or greater than, is strictly greater than) a threshold value. At 908, in some examples, user data associated with the selected contact of the user 102 is analyzed using a trained machine learning model(s) 122 to output a risk metric associated with the selected contact, and the risk metric determined for the selected contact may be used modify the incentive 120 associated with the selected contact and the user 102 (e.g., increase the incentive 120 if the selected contact is low risk, decrease the incentive 120 if the selected contact is high risk, etc.). As mentioned, the process 900 may be a sub-process of block 508 of the process 500, and, as such, modifying the incentive(s) 120 at block 906 may be performed as part of the dynamic determination of the incentive(s) 120 at block 508 of the process 500. In other words, in some examples, the incentive 120 determined for a selected contact at block 906 is part of dynamically determining the incentive(s) 120 associated with the user 102 at block 508 of the process 500.

Following block 906, or if it is determined to refrain from modifying the incentive(s) 120 (e.g., the process 900 follows the NO route from block 904), the next contact in the list of contacts may be selected at block 910, and the process 900 may iterate from block 904 for any number of contacts in the list. In some examples, the process 900 iterates through contacts that are unregistered with the payment service 108 (e.g., the process 900 may skip over contacts that are already registered with the payment service 108). Accordingly, using the process 900, different incentives 120 associated with different contacts of a user 102 may be determined for the user 102. An example of this is illustrated in the user interface 402 of FIG. 4A.

FIG. 10 is an example process 1000 for determining whether to modify an incentive(s) 120 based on the passage of time and/or additional user data received since determining the incentive 120, according to an implementation of the present subject matter. The process 1000 can be implemented by a system including one or more processors and memory storing computer-executable instructions to cause the one or more processors to perform the process 1000. In some examples, the process 1000 can be implemented by a processing device(s) 114 (e.g., server(s)) of the payment service computing platform 110. For discussion purposes, the process 1000 is described with reference to the previous figures.

At 1002, an amount of time that has lapsed since determining an incentive(s) 120 is monitored. For example, the incentive(s) 120 may be associated with an expiration or another period of time after which the incentive(s) 120 is reduced (e.g., decayed, decremented, etc.) or deactivated. In some examples, the payment service computing platform 110 may monitor the amount of time that has lapsed at block 1002. For example, an incentive(s) 120 may be dynamically determined (e.g., generated) for the user 102 at a first time, and the time that has lapsed since the first time may be monitored at block 1002.

At 1004, a determination is made as to whether a period of time (e.g., a predefined period of time) has lapsed since the first time when the incentive(s) 120 was determined. If the period of time has not lapsed, the process 1000 may follow the NO route from block 1004 to block 1002 where time monitoring continues. If the period of time has lapsed since the first time when the incentive(s) 120 was determined, the process 1000 may follow the YES route from block 1004 to block 1006 where the incentive(s) 120 is modified based on the determining that the period of time has lapsed. For example, after a period of time, the incentive(s) 120 may decrease, such as by decrementing the incentive the longer a user 102 waits to refer another user(s) to the payment service 108. This portion “leg” of the process 1000 may iterate from block 1002 any number of times until the incentive 120 is modified to a minimum or a maximum value.

At 1008, additional user data associated with a user 102 may be received since determining an incentive(s) 120 associated with the user 102. In some examples, the payment service computing platform 110 receives the additional user data at block 1008. For example, an incentive(s) 120 may be dynamically determined (e.g., generated) for the user 102 at a first time, and at a second time after the first time, additional user data associated with the user 102 is received. This may be based on the user 102 providing new information (e.g., a new email address, a new phone number, etc. In some examples, the additional user data may correspond to data regarding transactions initiated and/or completed using the payment application 106 (e.g., payments made to other users), assets purchased (e.g., stocks, cryptocurrency, etc.) using the payment application 106.

At 1010, a determination is made as to whether to modify the incentive(s) 120 based on the additional user data received at block 1008. If it is determined to refrain from modifying the incentive(s) 120, the process 1000 may follow the NO route from block 1010 to block 1008 where additional user data may be received at a subsequent time. If it is determined to modify the incentive, the process 1000 may follow the YES route from block 1010 to block 1006 where the incentive(s) 120 is modified based on the receiving of the additional user data. For example, if the additional user data is indicative of fraudulent behavior while using the payment service 108, the incentive(s) 120 may decrease, such as by decreasing the incentive to a minimum amount (e.g., zero). If, on the other hand, the additional user data is indicative of legitimate use of the payment service 108 and/or a low risk of the user 102 engaging in fraudulent behavior while using the payment service 108, the incentive may be increased. This portion “leg” of the process 1000 may iterate from block 1008 any number of times as additional user data is received.

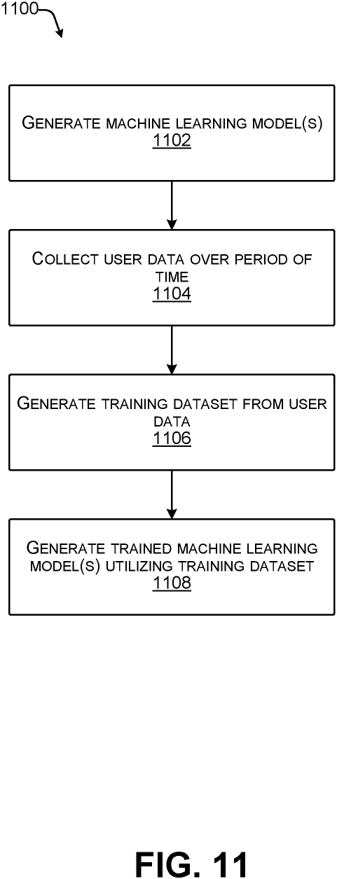

FIG. 11 is an example process 1100 for training a machine learning model(s), according to an implementation of the present subject matter. The process 1100 can be implemented by a system including one or more processors and memory storing computer-executable instructions to cause the one or more processors to perform the process 1100. In some examples, the process 1100 can be implemented by a processing device(s) 114 (e.g., server(s)) of the payment service computing platform 110. For discussion purposes, the process 1100 is described with reference to the previous figures.

At 1102, one or more machine learning models are generated. For example, the machine learning models may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases, such as the datastore(s) 116, and may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter predictive modelling may be performed to generate accurate predictive models.

At 1104, user data is collected over a period of time. The user data can be any suitable type of data pertaining to users 102 of the payment service, including data based on information (e.g., emails, phone numbers, card numbers, bank account numbers, etc.) provided by the users 102, transaction data, or the like. In some examples, the collected user data includes one or more of types of networks used by users 102 during the onboarding process, versions of the payment application 106 used during the onboarding process, or numbers of contacts in which a phone number is found during the onboarding process. In some examples, the collected user data may include factors associated with interactions with the payment application 106.

At 1106, a training dataset is generated from the user data. Generation of the training dataset may include formatting the user data into input vectors and/or signals for the machine learning model to intake, as well as associating the various data with the outcomes (e.g., labeling users and/or user accounts as associated with a particular behavior, such as fraudulent behavior, non-compliant behavior, abusive behavior, etc.). In some examples, the training dataset can include features and labels, or it may be unlabeled The features included in the training dataset can be represented by a set of features, such as in the form of an n-dimensional feature vector of quantifiable information about an attribute of the training dataset. The following is a list of example features that can be included in the training dataset for training the machine learning model(s) 122 described herein. However, it is to be appreciated that the following list of features is non-exhaustive, and features used in training may include additional features not described herein, and, in some cases, some, but not all, of the features listed herein. Example features included in the training dataset may include, without limitation, a number of user accounts created using an electronic device 104, a number of referrals using an IP address, whether a network used during an onboarding process is a home network or a public network, whether a phone number has been used for fraudulent behavior, a version of the payment application 106 used during an onboarding process, whether a phone number appears in lists of contacts associated with other users of the payment service, and, if so, how a number of lists, whether an email domain is a temporary email domain, risk scores received from one or more external services, whether an IP address was used during an onboarding process in the last hour, day, month, etc., a number and/or frequency of reports of a user engaging in fraudulent behavior while using the payment application 106, geolocations from which a user has logged-in to the payment application 106, a number of different payment instruments, phone numbers, mailing addresses, etc. that have been associated with a user account and/or how often these items have been changed, and/or any other suitable features that may be relevant in making a prediction as to a user’s propensity to engage in a particular behavior.

At 1108, one or more trained machine learning models 122 are generated utilizing the training dataset. Generation of the trained machine learning models may include updating parameters and/or weightings and/or thresholds utilized by the models to generate recommendations, user preferences, etc. based at least in part on the training dataset. Generating the trained machine learning model(s) 122 at block 1108 may include using any suitable learning technique, such as supervised learning, unsupervised learning, semi-supervised learning, reinforcement learning, and so on.

In accordance with the examples described herein, one or more trained machine learning models 122 generated at block 1108 can be used (e.g., for fraud reduction). For instance, the payment service computing platform 110 may receive user data 124 associated with a user 102, determine a risk metric associated with the user 102 based on the user data 124, and/or dynamically determine an incentive(s) 120 associated with the user 102 based on the risk metric and/or the user data 124. The risk metric and/or the incentive(s) 120 may be determined using the one or more trained machine learning models 122 generated at block 1108. As described herein, a user interface can be displayed via a payment application 106 executing on the electronic device 104 of the user 102, wherein the user interface presents an interactive element(s) for receiving the incentive(s) 120 in exchange for the user 102 referring at least one other user to the payment service 108.

As another example, a merchant may provide a service (e.g., a capital loan service, a buy now pay later loan service, a loyalty program, etc.). Accordingly, the merchant may use the one or more trained machine learning models 122 generated at block 1108 (e.g., for fraud reduction). For instance, a server(s) may receive user data 124 associated with a customer of the merchant, determine a risk metric associated with the customer based on the user data 124, and/or dynamically determine an incentive(s) 120 associated with the customer based on the risk metric and/or the user data 124. The risk metric and/or the incentive(s) 120 may be determined using the one or more trained machine learning models 122 generated at block 1108. The server(s) can then cause a user interface to be displayed via a payment application 106 executing on the electronic device 104 of the customer, wherein the user interface presents an interactive element(s) for receiving the incentive(s) in exchange for the customer referring at least one other user to the merchant’s service.

As another example, service provider of a music, podcast and/or video streaming service (“streaming service”) may use the one or more trained machine learning models 122 generated at block 1108 (e.g., for fraud reduction). For instance, a server(s) may receive user data 124 associated with a user 102 (e.g., an artist, a streamer, etc.), determine a risk metric associated with the user based on the user data 124, and/or dynamically determine an incentive(s) 120 associated with the user 102 based on the risk metric and/or the user data 124. The risk metric and/or the incentive(s) 120 may be determined using the one or more trained machine learning models 122 generated at block 1108. The server(s) can then cause a user interface to be displayed via a payment application 106 executing on the electronic device 104 of the user 102, wherein the user interface presents an interactive element(s) for receiving the incentive(s) 120 in exchange for the user 102 referring at least one other user (e.g., other artists, streamers, etc.) to the streaming service.

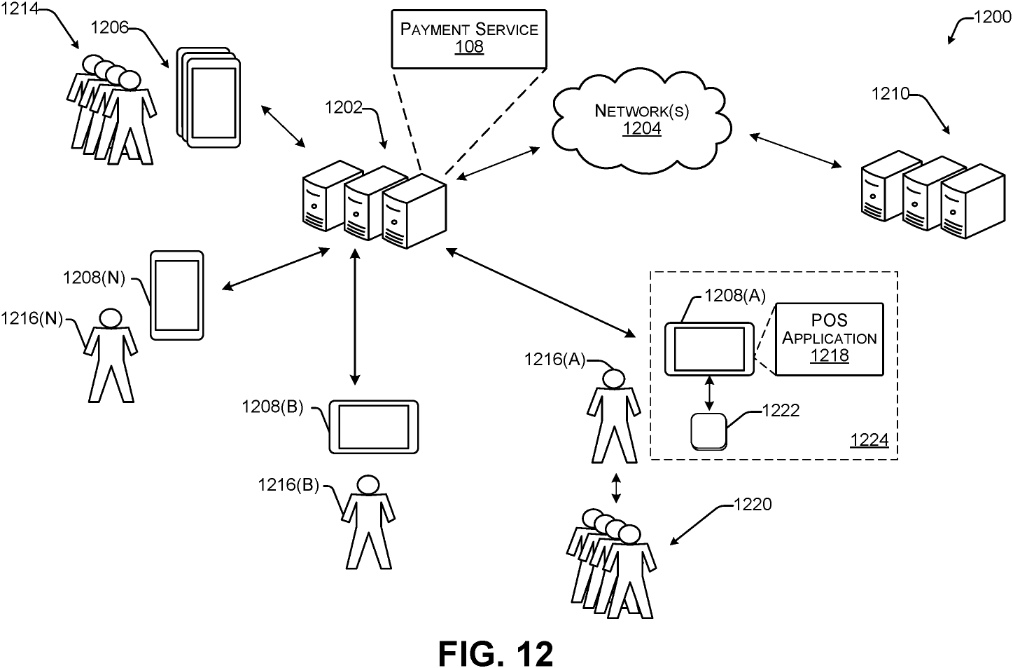

FIG. 12 is an example environment 1200 for performing techniques described herein. The environment 1200 includes server(s) 1202 that can communicate over a network 1204 with user devices 1206 (which, in some examples can be merchant devices 1208 (individually, 1208(A)-1208(N))) and/or server(s) 1210 associated with third-party service provider(s). The server(s) 1202 can be associated with a service provider that can provide one or more services for the benefit of users 1214, as described below. Actions attributed to the service provider can be performed by the server(s) 1202.

For example, the server(s) 1202 may be the same as or similar to the payment service computing platform 110 and/or the processing device(s) 114 (e.g., server(s)) introduced in FIG. 1, and the server(s) 1202 may implement the payment service 108, which may include the trained machine learning model(s) 122, the risk component 126, the incentive component 128, and/or the ranking component 130, as described herein. Furthermore, the network(s) 1204 may be the same as or similar to the network(s) 112 introduced in FIG. 1.

The environment 1200 can include a plurality of user devices 1206, as described above. Each one of the plurality of user devices 1206 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. The user devices 1206 (and in some examples, the merchant devices 1208) may be the same as or similar to the electronic devices 104 introduced in FIG. 1. In some examples, individual ones of the user devices can be operable by users 1214. The users 1214 can be referred to as customers, buyers, merchants, sellers, borrowers, employees, employers, payors, payees, couriers and so on. The users 1214 can interact with the user devices 1206 via user interfaces presented via the user devices 1206. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1206 can have an instance or versioned instance of an application, which can be downloaded from an application store, for example, which can present the user interface(s) described herein. In at least one example, a user 1214 can interact with the user interface via touch input, spoken input, or any other type of input.

As described above, in at least one example, the users 1214 can include merchants 1216 (individually, 1216(A)-1216(N)). The users 1214 (and in some examples, the merchants 1216) may be the same as or similar to the users 102 introduced in FIG. 1. In an example, the merchants 1216 can operate respective merchant devices 1208, which can be user devices 1206 configured for use by merchants 1216. For the purpose of this discussion, a “merchant” can be any entity that offers items (e.g., goods or services) for purchase or other means of acquisition (e.g., rent, borrow, barter, etc.). The merchants 1216 can offer items for purchase or other means of acquisition via brick-and-mortar stores, mobile stores (e.g., pop-up shops, food trucks, etc.), online stores, combinations of the foregoing, and so forth. In some examples, at least some of the merchants 1216 can be associated with a same entity but can have different merchant locations and/or can have franchise/franchisee relationships. In additional or alternative examples, the merchants 1216 can be different merchants. That is, in at least one example, the merchant 1216(A) is a different merchant than the merchant 1216(B) and/or the merchant 1216(C).

In accordance with the examples described herein, the server(s) 1202 may use the trained machine learning model(s) 122 of the payment service 108 for fraud reduction. For instance, the server(s) 1202 may receive, from a user device 1206, user data associated with a user 1214, determine a risk metric associated with the user 1214 based on the user data, and/or dynamically determine an incentive(s) 120 associated with the user 1214 based on the risk metric and/or the user data. The risk metric and/or the incentive(s) 120 may be determined using a trained machine learning model(s) 122 that is trained based on previously collected user data from one or more of the users 1214 (and, in some examples, the merchants 1216). The server(s) 1202 can then cause a user interface to be displayed via a payment application executing on the user device 1206 of the user 1214, wherein the user interface presents an interactive element(s) for receiving the incentive(s) 120 in exchange for the user 1214 referring at least one other user (e.g., another user 1214, a merchant 1216, a customer 1220 of a merchant 1216, etc.) to the payment service 108.

As another example, a merchant 1216 may provide a service (e.g., a capital loan service, a buy now pay later loan service, a loyalty program, etc.). Accordingly, the merchant 1216 may use the trained machine learning model(s) 122 for fraud reduction. For instance, the server(s) 1202 may receive, from a user device of a customer 1220 of the merchant 1216, user data associated with a customer 1220, determine a risk metric associated with the customer 1220 based on the user data, and/or dynamically determine an incentive(s) 120 associated with the customer 1220 based on the risk metric and/or the user data. The risk metric and/or the incentive(s) 120 may be determined using a trained machine learning model(s) 122 that is trained based on previously collected user data from one or more of the customers 1220. The server(s) 1202 can then cause a user interface to be displayed via a payment application executing on the user device of the customer 1220, wherein the user interface presents an interactive element(s) for receiving the incentive(s) in exchange for the customer 1220 referring at least one other customer 1220 to the merchant’s service.

As another example, service provider of a music, podcast and/or video streaming service (“streaming service”) may use the trained machine learning model(s) 122 for fraud reduction. For instance, the server(s) 1202 may receive, from a user device 1206 of a user 1214 (e.g., an artist, a streamer, etc.), user data associated with a user 1214, determine a risk metric associated with the user 1214 based on the user data, and/or dynamically determine an incentive(s) 120 associated with the user 1214 based on the risk metric and/or the user data. The risk metric and/or the incentive(s) 120 may be determined using a trained machine learning model(s) 122 that is trained based on previously collected user data from one or more of the users 1214 of the streaming service. The server(s) 1202 can then cause a user interface to be displayed via a payment application executing on the user device 1206 of the user 1214, wherein the user interface presents an interactive element(s) for receiving the incentive(s) in exchange for the user 1214 referring at least one other user (e.g., other artists, streamers, etc.) to the streaming service.

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships-can be referred to as merchants having different merchant locations and/or different commerce channels.

Each merchant device 1208 can have an instance of a POS application 1218 stored thereon. In some examples, the POS application 1218 may be the same as or similar to the payment application 106 introduced in FIG. 1. The POS application 1218 can configure the merchant device 1208 as a POS terminal, which enables the merchant 1216(A) to interact with one or more customers 1220. As described above, the users 1214 can include customers, such as the customers 1220 shown as interacting with the merchant 1216(A). For the purpose of this discussion, a “customer” can be any entity that acquires items from merchants. While only two customers 1220 are illustrated in FIG. 12, any number of customers 1220 can interact with the merchants 1216. Further, while FIG. 12 illustrates the customers 1220 interacting with the merchant 1216(A), the customers 1220 can interact with any of the merchants 1216.

In at least one example, interactions between the customers 1220 and the merchants 1216 that involve the exchange of funds (from the customers 1220) for items (from the merchants 1216) can be referred to as “transactions.” In at least one example, the POS application 1218 can determine transaction data associated with the POS transactions. Transaction data can include payment information, which can be obtained from a reader device 1222 associated with the merchant device 1208(A), user authentication data, purchase amount information, point-of-purchase information (e.g., item(s) purchased, date of purchase, time of purchase, etc.), etc. The POS application 1218 can send transaction data to the server(s) 1202 such that the server(s) 1202 can track transactions of the customers 1220, merchants 1216, and/or any of the users 1214 over time. Furthermore, the POS application 1218 can present a UI to enable the merchant 1216(A) to interact with the POS application 1218 and/or the service provider via the POS application 1218.

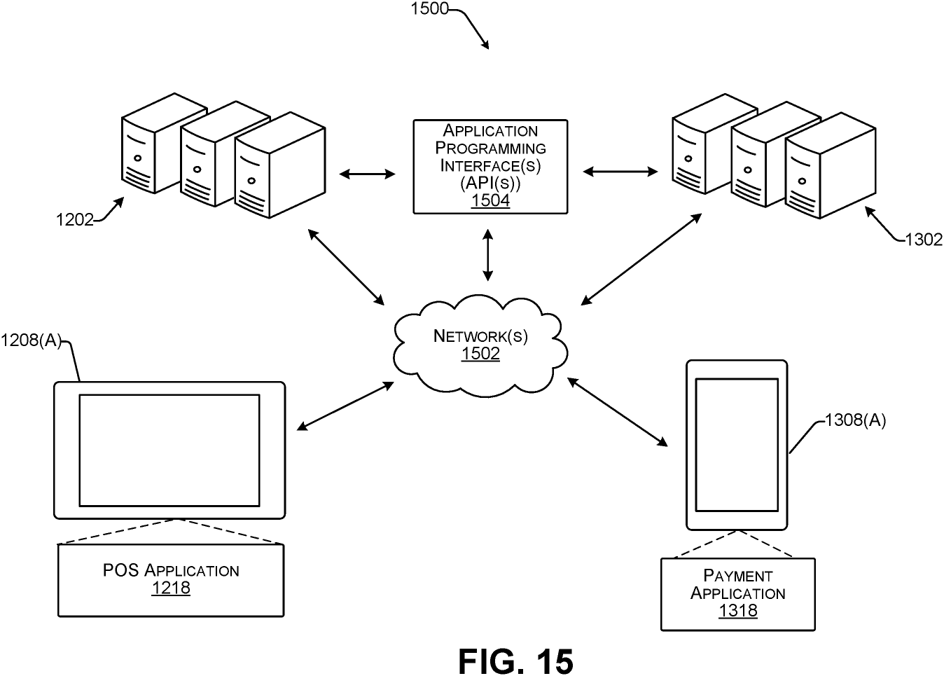

In at least one example, the merchant device 1208(A) can be a special-purpose computing device configured as a POS terminal (via the execution of the POS application 1218). In at least one example, the POS terminal may be connected to a reader device 1222, which is capable of accepting a variety of payment instruments, such as credit cards, debit cards, gift cards, short-range communication based payment instruments, and the like, as described below. In at least one example, the reader device 1222 can plug in to a port in the merchant device 1208(A), such as a microphone port, a headphone port, an audio-jack, a data port, or other suitable port. In additional or alternative examples, the reader device 1222 can be coupled to the merchant device 1208(A) via another wired or wireless connection, such as via a Bluetooth®, BLE, and so on. Additional details are described below with reference to FIG. 15. In some examples, the reader device 1222 can read information from alternative payment instruments including, but not limited to, wristbands and the like.

In some examples, the reader device 1222 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 1222, and communicate with the server(s) 1202, which can provide, among other services, a payment processing service. The server(s) 1202 associated with the service provider can communicate with server(s) 1210, as described below. In this manner, the POS terminal and reader device 1222 may collectively process transaction(s) between the merchants 1216 and customers 1220. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1222 of the POS system 1224 are shown as separate devices, in additional or alternative examples, the POS terminal and the reader device 1222 can be part of a single device. In some examples, the reader device 1222 can have a display integrated therein for presenting information to the customers 1220. In additional or alternative examples, the POS terminal can have a display integrated therein for presenting information to the customers 1220. POS systems, such as the POS system 1224, may be mobile, such that POS terminals and reader devices may process transactions in disparate locations across the world. POS systems can be used for processing card-present transactions and card-not-present (CNP) transactions, as described below.

A card-present transaction is a transaction where both a customer 1220 and his or her payment instrument are physically present at the time of the transaction. Card-present transactions may be processed by swipes, dips, taps, or any other interaction between a physical payment instrument (e.g., a card), or otherwise present payment instrument, and a reader device 1222 whereby the reader device 1222 is able to obtain payment data from the payment instrument. A swipe is a card-present transaction where a customer 1220 slides a card, or other payment instrument, having a magnetic strip through a reader device 1222 that captures payment data contained in the magnetic strip. A dip is a card-present transaction where a customer 1220 inserts a payment instrument having an embedded microchip (i.e., chip) into a reader device 1222 first. The dipped payment instrument remains in the payment reader until the reader device 1222 prompts the customer 1220 to remove the card, or other payment instrument. While the payment instrument is in the reader device 1222, the microchip can create a one-time code which is sent from the POS system 1224 to the server(s) 1210 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 1220 may tap or hover his or her payment instrument (e.g., card, electronic device such as a smart phone running a payment application, etc.) over a reader device 1222 to complete a transaction via short-range communication (e.g., NFC, RFID, Bluetooth®, BLE, etc.). Short-range communication enables the payment instrument to exchange information with the reader device 1222. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 1224, the server(s) 1202, and/or the server(s) 1210 may exchange payment information and transaction data to determine whether transactions are authorized. For example, the POS system 1224 may provide encrypted payment data, user authentication data, purchase amount information, point-of-purchase information, etc. (collectively, transaction data) to server(s) 1202 over the network(s) 1204. The server(s) 1202 may send the transaction data to the server(s) 1210. As described above, in at least one example, the server(s) 1210 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 1210 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 1210 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 1210 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 1210 associated therewith), and a payment authorization message is communicated from the issuer to the POS device via a path opposite of that described above, or via an alternate path.

As described above, the server(s) 1210, which can be associated with payment service provider(s), may determine whether the transaction is authorized based on the transaction data, as well as information relating to parties to the transaction (e.g., the customer 1220 and/or the merchant 1216(A)). The server(s) 1210 may send an authorization notification over the network(s) 1204 to the server(s) 1202, which may send the authorization notification to the POS system 1224 over the network(s) 1204 to indicate whether the transaction is authorized. The server(s) 1202 may also transmit additional information such as transaction identifiers to the POS system 1224. In one example, the server(s) 1202 may include a merchant application and/or other functional components for communicating with the POS system 1224 and/or the server(s) 1210 to authorize or decline transactions.

Based on the authentication notification that is received by the POS system 1224 from server(s) 1202, the merchant 1216(A) may indicate to the customer 1220 whether the transaction has been approved. In some examples, approval may be indicated at the POS system 1224, for example, at a display of the POS system 1224. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 1214 can access all of the services of the service provider. In other examples, the users 1214 can have gradated access to the services, which can be based on risk tolerance, IDV outputs, subscriptions, and so on. In at least one example, access to such services can be availed to the merchants 1216 via the POS application 1218. In additional or alternative examples, each service can be associated with its own access point (e.g., application, web browser, etc.).

The service provider can offer payment processing services for processing payments on behalf of the merchants 1216, as described above. For example, the service provider can provision payment processing software, payment processing hardware and/or payment processing services to merchants 1216, as described above, to enable the merchants 1216 to receive payments from the customers 1220 when conducting POS transactions with the customers 1220. For instance, the service provider can enable the merchants 1216 to receive cash payments, payment card payments, and/or electronic payments from customers 1220 for POS transactions and the service provider can process transactions on behalf of the merchants 1216.

As the service provider processes transactions on behalf of the merchants 1216, the service provider can maintain accounts or balances for the merchants 1216 in one or more ledgers. For example, the service provider can analyze transaction data received for a transaction to determine an amount of funds owed to a merchant 1216(A) for the transaction. In at least one example, such an amount can be a total purchase price less fees charged by the service provider for providing the payment processing services. Based on determining the amount of funds owed to the merchant 1216(A), the service provider can deposit funds into an account of the merchant 1216(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 1216(A) to a bank account of the merchant 1216(A) that is held at a bank or other financial institution (e.g., associated with the server(s) 1210). Scheduled deposits can occur at a prearranged time after a POS transaction is funded, which can be a business day after the POS transaction occurred, or sooner or later. In some examples, the merchant 1216(A) can access funds prior to a scheduled deposit. For instance, the merchant 1216(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 1216(A) can have a payment instrument that is linked to the stored balance that enables the merchant to access the funds without first transferring the funds from the account managed by the service provider to the bank account of the merchant 1216(A).

In at least one example, the service provider may provide inventory management services. That is, the service provider may provide inventory tracking and reporting. Inventory management services may enable the merchant 1216(A) to access and manage a database storing data associated with a quantity of each item that the merchant 1216(A) has available (i.e., an inventory). Furthermore, in at least one example, the service provider can provide catalog management services to enable the merchant 1216(A) to maintain a catalog, which can be a database storing data associated with items that the merchant 1216(A) has available for acquisition (i.e., catalog management services). In at least one example, the catalog may include a plurality of data items and a data item of the plurality of data items may represent an item that the merchant 1216(A) has available for acquisition. The service provider can offer recommendations related to pricing of the items, placement of items on the catalog, and multiparty fulfilment of the inventory.

In at least one example, the service provider can provide business banking services, which allow the merchant 1216(A) to track deposits (from payment processing and/or other sources of funds) into an account of the merchant 1216(A), payroll payments from the account (e.g., payments to employees of the merchant 1216(A)), payments to other merchants (e.g., business-to-business) directly from the account or from a linked debit card, withdrawals made via scheduled deposit and/or instant deposit, etc. Furthermore, the business banking services can enable the merchant 1216(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 1216 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower’s short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower’s consumer purchase (e.g., a consumer loan). In at least one example, a borrower can submit a request for a loan to enable the borrower to purchase an item from a merchant, which can be one of the merchants 1216. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider associates capital to a merchant or customer’s debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 1214 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 1216. In at least one example, the service provider can recommend and/or generate content items to supplement omni-channel presences of the merchants 1216. That is, if a merchant of the merchants 1216 has a web page, the service provider—via the web-development or other services-can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 1214 to set schedules for scheduling appointments and/or users 1214 to schedule appointments.

In some examples, the service provider can provide restaurant management services to enable users 1214 to make and/or manage reservations, to monitor front-of-house and/or back-of-house operations, and so on. In such examples, the merchant device(s) 1208 and/or server(s) 1202 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 1214 who can travel between locations to perform services for a requesting user 1214 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 1206.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer’s order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 1214, voice inputs into a virtual assistant or the like, to determine intents of user(s) 1214. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1214 may be new to the service provider such that the user 1214 that has not registered (e.g., subscribed to receive access to one or more services offered by the service provider) with the service provider. The service provider can offer onboarding services for registering a potential user 1214 with the service provider. In some examples, onboarding can involve presenting various questions, prompts, and the like to a potential user 1214 to obtain information that can be used to generate a profile for the potential user 1214. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 1214 providing all necessary information, the potential user 1214 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 1210). That is, the service provider can offer IDV services to verify the identity of users 1214 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 1214 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 1210 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 1202) and/or the server(s) 1210 via the network(s) 1204. In some examples, the merchant device(s) 1208 are not capable of connecting with the service provider (e.g., the server(s) 1202) and/or the server(s) 1210, due to a network connectivity issue, for example. In additional or alternative examples, the server(s) 1202 are not capable of communicating with the server(s) 1210 due to network connectivity issue, for example. In such examples, devices may operate in “offline” mode where at least some payment data is stored (e.g., on the merchant device(s) 1208) and/or the server(s) 1202 until connectivity is restored and the payment data can be transmitted to the server(s) 1202 and/or the server(s) 1210 for processing.

In at least one example, the service provider can be associated with a hub, such as an order hub, an inventory hub, a fulfillment hub and so on, which can enable integration with one or more additional service providers (e.g., associated with the additional server(s) 1210). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 1206 that are in communication with one or more server computing devices 1202 of the service provider. That is, techniques described herein are directed to a specific implementation-or, a practical application-of utilizing a distributed system of user devices 1206 that are in communication with one or more server computing devices 1202 of the service provider to perform a variety of services, as described above. The unconventional configuration of the distributed system described herein enables the server(s) 1202 that are remotely-located from end-users (e.g., users 1214) to intelligently offer services based on aggregated data associated with the end-users, such as the users 1214 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant’s cash flow, predict needs, preemptively offer recommendations or services, such as capital, coupons, etc., and/or enable money movement between disparate accounts (merchant’s, another merchant’s, or even payment service’s) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1214 and user devices 1206. Furthermore, such features are changed dynamically based on the profiles of the users involved interacting with the GUIs. As such, techniques described herein are directed to improvements to computing systems.

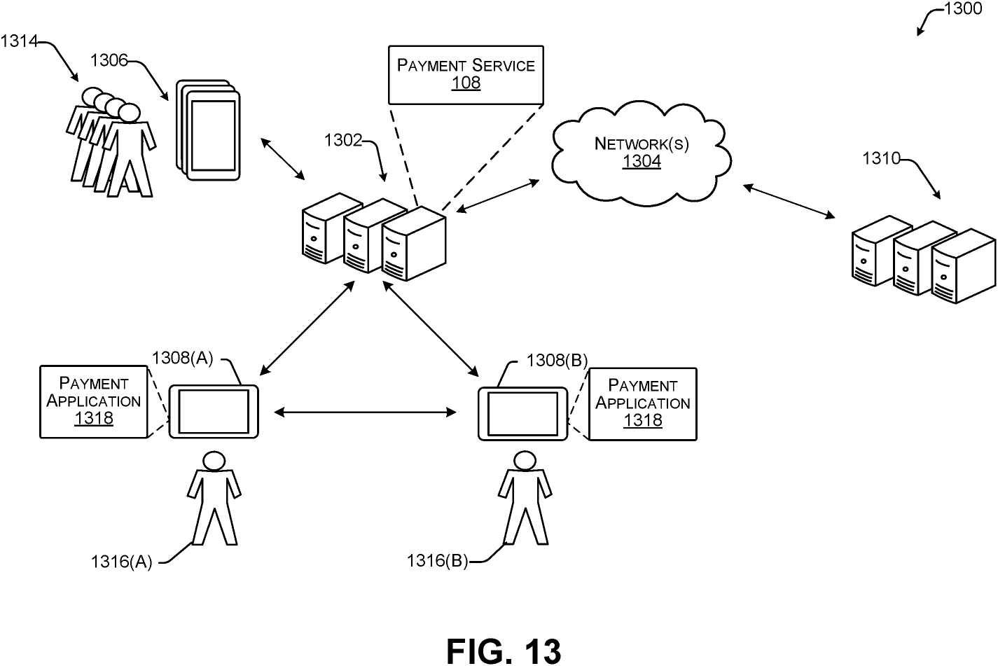

FIG. 13 is an example environment 1300 for performing techniques described herein. The environment 1300 includes server(s) 1302 that can communicate over a network 1304 with user devices 1306 (which, in some examples can be user devices 1308 (individually, 1308(A), 1308(B)) and/or server(s) 1310 associated with third-party service provider(s). The server(s) 1302 can be associated with a service provider that can provide one or more services for the benefit of users 1314, as described below. Actions attributed to the service provider can be performed by the server(s) 1302. In some examples, the service provider referenced in FIG. 12 can be the same or different than the service provider referenced in FIG. 13.

For example, the server(s) 1302 may be the same as or similar to the payment service computing platform 110 and/or the processing device(s) 114 (e.g., server(s)) introduced in FIG. 1, and the server(s) 1302 may implement the payment service 108, which may include the trained machine learning model(s) 122, the risk component 126, the incentive component 128, and/or the ranking component 130, as described herein. Furthermore, the network(s) 1304 may be the same as or similar to the network(s) 112 introduced in FIG. 1.

The environment 1300 can include a plurality of user devices 1306, as described above. Each one of the plurality of user devices 1306 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. The user devices 1306 (and in some examples, the user devices 1308) may be the same as or similar to the electronic devices 104 introduced in FIG. 1. In some examples, individual ones of the user devices can be operable by users 1314. The users 1314 can be referred to as customers, buyers, merchants, sellers, borrowers, employees, employers, payors, payees, couriers and so on. The users 1314 can interact with the user devices 1306 via user interfaces presented via the user devices 1306. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1306 can have an instance or versioned instance of an application, which can be downloaded from an application store, for example, which can present the user interface(s) described herein. In at least one example, a user 1314 can interact with the user interface via touch input, spoken input, or any other type of input.

In at least one example, the service provider can provide a peer-to-peer payment service that enables peer-to-peer payments between two or more users 1314. Two users, user 1316(A) and user 1316(B) are illustrated in FIG. 13 as “peers” in a peer-to-peer payment. In at least one example, the service provider can communicate with instances of a payment application 1318 (or other access point) installed on devices 1306 configured for operation by users 1314. In an example, an instance of the payment application 1318 executing on a first device 1308(A) operated by a payor (e.g., user 1316(A)) can send a request to the service provider to transfer an asset (e.g., fiat currency, non-fiat currency, cryptocurrency, securities, gift cards, and/or related assets) from the payor to a payee (e.g., user 1316(B)) via a peer-to-peer payment. In some examples, assets associated with an account of the payor are transferred to an account of the payee. In some examples, assets can be held at least temporarily in an account of the service provider prior to transferring the assets to the account of the payee. The users 1314 (and in some examples, the users 1316) may be the same as or similar to the users 102 introduced in FIG. 1, and the payment application 1318 may be the same as or similar to the payment application 106 introduced in FIG. 1.

In accordance with the examples described herein, the server(s) 1302 may use the trained machine learning model(s) 122 of the payment service 108 for fraud reduction. For instance, the server(s) 1302 may receive, from a user device 1306, 1308, user data associated with a user 1314, 1316, determine a risk metric associated with the user 1314, 1316 based on the user data, and/or dynamically determine an incentive(s) 120 associated with the user 1314, 1316 based on the risk metric and/or the user data. The risk metric and/or the incentive(s) 120 may be determined using a trained machine learning model(s) 122 that is trained based on previously collected user data from one or more of the users 1314, 1316. The server(s) 1302 can then cause a user interface to be displayed via a payment application executing on the user device 1306, 1318 of the user 1314, 1316, wherein the user interface presents an interactive element(s) for receiving the incentive(s) 120 in exchange for the user 1314, 1316 referring at least one other user 1314, 1316 to the payment service 108.

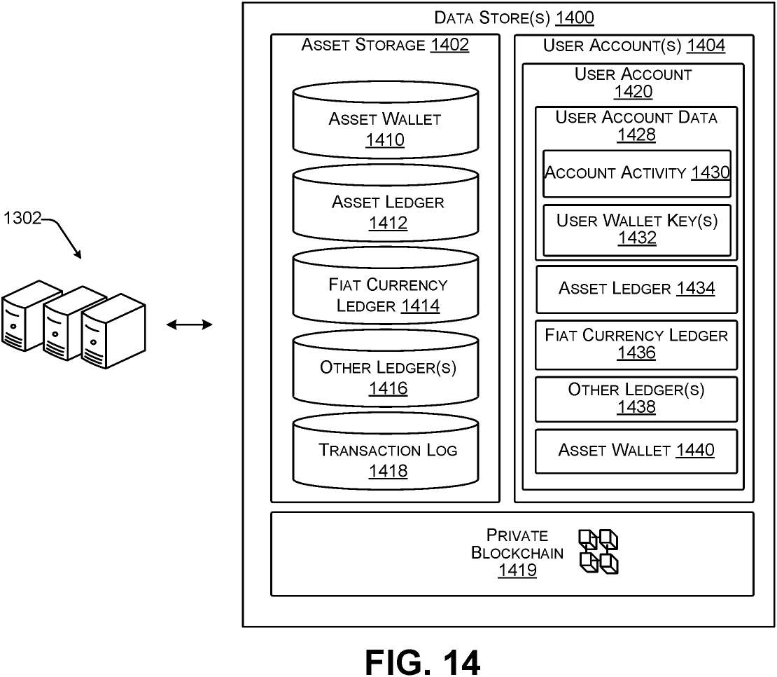

In some examples, the service provider can utilize a ledger system to track transfers of assets between users 1306. FIG. 14, below, provides additional details associated with such a ledger system. The ledger system can enable users 1306 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 1318 executing on user device(s) of payee(s). As an example, the service provider can transfer assets from an account of user 1316(A) to an account of the user 1316(B) and can send a notification to the user device 1308(B) of the user 1316(B) for presentation via a user interface. The notification can indicate that a transfer is in process, a transfer is complete, or the like. In some examples, the service provider can send additional or alternative information to the instances of the payment application 1318 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor’s financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 1302 to treat the inputs as a request from the payor to transfer assets, where detection of the syntax triggers a transfer of assets. The currency indicator can correspond to various currencies including but not limited to, dollar ($), euro (€), pound (£), rupee (7), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 1318 executing on the user devices 1306. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider’s media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 13 or a third-party service provider associated with the server(s) 1310. In examples where the content provider is a third-party service provider, the server(s) 1310 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 13. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 1306 (e.g., mobile device or conventional personal computer (PC)) based on instructions transmitted to and from the server(s) 1302 (which, in such an example can be called a “messaging server”). In some instances, the messaging application can include a payment application with messaging capability that enables users of the payment application to communicate with one another. In such instances, the payment application can be executed on a user device 1306 based on instructions transmitted to and from the server(s) 1302 (e.g., the payment service discussed in this description or another payment service that supports payment transactions). In some examples, the messaging application can be provided by a third-party service provider associated with the server(s) 1310. In examples where the messaging application is a third-party service provider, the server(s) 1310 can be accessible via one or more APIs or other integrations.

As described above, the service provider can facilitate peer-to-peer transactions, which can enable users 1306 to transfer fiat currency, non-fiat currency, cryptocurrency, securities, or other assets, or portions thereof, to other users 1306. In at least one example, individual users can be associated with user accounts. Additional details associated with user accounts and the transfer of assets between users 1306 are described below with reference to FIG. 14.

Furthermore, the service provider of FIG. 13 can enable users 1306 to perform banking transactions via instances of the payment application 1318. For example, users can configure direct deposits or other deposits for adding assets to their various ledgers/balances. Further, users 1306 can configure bill pay, recurring payments, and/or the like using assets associated with their accounts. In addition to sending and/or receiving assets via peer-to-peer transactions, users 1306 buy and/or sell assets via asset networks such as cryptocurrency networks, securities networks, and/or the like.

FIG. 14 is an example data store 1400 used for performing techniques described herein. The data store(s) 1400 can be associated with the server(s) 1302. The data store(s) 1400 may be the same as or similar to the data store(s) 116 introduced in FIG. 1.

In at least one example, the data store(s) 1400 can store assets in an asset storage 1402, as well as data in user account(s) 1404, merchant account(s) 1406, and/or customer account(s) 1408. In at least one example, the asset storage 1402 can be used to store assets managed by the service provider of FIG. 13. In at least one example, the asset storage 1402 can be used to record whether individual of the assets are registered to users. For example, the asset storage 1402 can include an asset wallet 1410 for storing records of assets owned by the service provider of FIG. 13, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 1310 can be associated therewith. In some examples, the asset wallet 1410 can communication with the asset network via one or more components associated with the server(s) 1302.

The asset wallet 1410 can be associated with one or more addresses and can vary addresses used to acquire assets (e.g., from the asset network(s)) so that its holdings are represented under a variety of addresses on the asset network. In examples where the service provider of FIG. 13 has its own holdings of cryptocurrency (e.g., in the asset wallet 1410), a user can acquire cryptocurrency directly from the service provider of FIG. 13. In some examples, the service provider of FIG. 13 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1402 may contain ledgers that store records of assignments of assets to users 1306. Specifically, the asset storage 1402 may include asset ledger 1410, fiat currency ledger 1414, and other ledger(s) 1416, which can be used to record transfers of assets between users 1306 of the service provider and/or one or more third-parties (e.g., merchant network(s), payment card network(s), ACH network(s), equities network(s), the asset network, securities networks, etc.). In doing so, the asset storage 1402 can maintain a running balance of assets managed by the service provider of FIG. 13. The ledger(s) of the asset storage 1402 can further indicate some of the running balance for each of the ledger(s) stored in the asset storage 1402 is assigned or registered to one or more user account(s) 1404.

In at least one example, the asset storage 1402 can include transaction logs 1418, which can include records of past transactions involving the service provider of FIG. 13. In at least one example, transaction data, as described herein, can be stored in association with the transaction logs 1418.

In some examples, the data store(s) 1400 can store a private blockchain 1419. A private blockchain 1419 can function to record sender addresses, recipient addresses, public keys, values of cryptocurrency transferred, and/or can be used to verify ownership of cryptocurrency tokens to be transferred. In some examples, the service provider of FIG. 13 can record transactions taking place within the service provider of FIG. 13 involving cryptocurrency until the number of transactions has exceeded a determined limit (e.g., number of transactions, storage space allocation, etc.). Based at least in part on determining that the limit has been reached, the service provider of FIG. 13 can publish the transactions in the private blockchain 1419 to a public blockchain (e.g., associated with the asset network), where miners can verify the transactions and record the transactions to blocks on the public blockchain. In at least one example, the service provider of FIG. 13 can participate as miner(s) at least for its transactions to be posted to the public blockchain.

In at least one example, the data store(s) 1400 can store and/or manage accounts, such as user account(s) 1404, merchant account(s) 1406, and/or customer account(s) 1408. In at least one example, the user account(s) 1404 may store records of user accounts associated with the users 1314. In at least one example, the user account(s) 1404 can include a user account 1420, which can be associated with a user (of the users 1314). Other user accounts of the user account(s) 1404 can be similarly structured to the user account 1420, according to some examples. In other examples, other user accounts may include more or less data and/or account information than that provided by the user account 1420. In at least one example, the user account 1420 can include user account data 1428, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1428 can include account activity 1 4 30 and user wallet key(s) 14 32. The account activity 1 4 30 may include a transaction log for recording transactions associated with the user account 14 20. In some examples, the user wallet key(s) 1432 can include a public-private key-pair and a respective address associated with the asset network or other asset networks. In some examples, the user wallet key(s) 14 32 may include one or more key pairs, which can be unique to the asset network or other asset networks.

In addition to the user account data 1428, the user account 1420 can include ledger(s) for account(s) managed by the service provider of FIG. 13, for the user. For example, the user account 1420 may include an asset ledger 1434, a fiat currency ledger 1 4 36, and/or one or more other ledgers 1438. The ledger(s) can indicate that a corresponding user utilizes the service provider of FIG. 13 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 13.

In some examples, the asset ledger 1434 can store a balance for each of one or more cryptocurrencies (e.g., Bitcoin, Ethereum, Litecoin, etc.) registered to the user account 14 20. In at least one example, the asset ledger 1434 can further record transactions of cryptocurrency assets associated with the user account 1420. For example, the user account 1420 can receive cryptocurrency from the asset network using the user wallet key(s) 1 4 32. In some examples, the user wallet key(s) 1432 may be generated for the user upon request. User wallet key(s) 1432 can be requested by the user in order to send, exchange, or otherwise control the balance of cryptocurrency held by the service provider of FIG. 13 (e.g., in the asset wallet 1410) and registered to the user. In some examples, th e user wallet key(s) 1 4 32 may not be generated until a user account requires such. This on-the-fly wallet key generation provides enhanced security features for users, reducing the number of access points to a user account’s balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 13 and the value is credited as a balance in asset ledger 1434), by purchasing currency in the form associated with the account using currency in a different form (e.g., buying a value of cryptocurrency from the service provider of FIG. 13 using a value of fiat currency reflected in fiat currency ledger, and crediting the value of cryptocurrency in asset ledger 1434), or by conducting a transaction with another user (customer or merchant) of the service provider of FIG. 13 wherein the account receives incoming currency (which can be in the form associated with the account or a different form, in which the incoming currency may be converted to the form associated with the account). In some examples, the user account data 1428 can include preferences for maintaining balances of individual of the ledgers. For example, the service provider of FIG. 13 can automatically debit the fiat currency ledger 1436 to increase the asset ledger 1434, or another account associated with the user whenever the cryptocurrency balance (e.g., of the asset ledger 1434) falls below a stated level (e.g., a threshold). Conversely, in some embodiments, the service provider of FIG. 13 can automatically credit the fiat currency ledger 1436 to decrease the asset ledger 1434 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s) 120) unrelated to the service provider of FIG. 13 (i.e., an external account). In at least one example, the user can transfer all or a portion of a balance of the cryptocurrency stored in the third-party cryptocurrency wallet to the service provider of FIG. 13. Such a transaction can require the user to transfer an amount of the cryptocurrency in a message signed by user’s private key to an address provided by the service provider of FIG. 13. In at least one example, the transaction can be sent to miners to bundle the transaction into a block of transactions and to verify the authenticity of the transactions in the block. Once a miner has verified the block, the block is written to a public, distributed blockchain where the service provider of FIG. 13 can then verify that the transaction has been confirmed and can credit the user’s asset ledger 1434 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 13. As described above, in some examples, the service provider of FIG. 13 can acquire cryptocurrency from a third-party source (e.g., associated with the third-party server(s) 118). In such examples, the asset wallet 1410 can be associated with different addresses and can vary addresses used to acquire cryptocurrency so that its holdings are represented under a variety of addresses on a blockchain. When the service provider of FIG. 13 has their own holdings of cryptocurrency, users can acquire cryptocurrency directly from the service provider of FIG. 13. In some examples, the service provider of FIG. 13 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 13 has its own cryptocurrency assets, cryptocurrency transferred in a transaction (e.g., data with address provided for receipt of transaction and a balance of cryptocurrency transferred in the transaction) can be stored in the asset wallet 1410. In at least one example, the service provider of FIG. 13 can credit the asset ledger 1434 of the user. Additionally, while the service provider of FIG. 13 recognizes that the user retains the value of the transferred cryptocurrency through crediting the asset ledger 1434, any person that inspects the blockchain will see the cryptocurrency as having been transferred to the service provider of FIG. 13. In some examples, the asset wallet 1410 can be associated with many different addresses. In such examples, any person that inspects the blockchain may not easily associate all cryptocurrency stored in asset wallet 1410 as belonging to the same entity. It is this presence of a private ledger that is used for real-time transactions and maintained by the service provider of FIG. 13, combined with updates to the public ledger at other times, that allows for extremely fast transactions using cryptocurrency to be achieved. In some examples, the “private ledger” can refer to the asset ledger 1410, which in some examples, can utilize the private blockchain 1419, as described herein. The “public ledger” can correspond to a public blockchain associated with the asset network.

In at least one example, a user’s asset ledger 1434, fiat currency ledger 1436, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1434. In some examples, a user can receive fiat currency or another currency in the form of payment for a transaction with another user. In at least one example, at least a portion of such funds can be converted into cryptocurrency by the service provider of FIG. 13 and used to fund the asset ledger 1434 of the user.

As addressed above, in some examples, users can also have other accounts maintained by the service provider of FIG. 13. For example, a user can also have an account in U.S. dollars, which can be tracked, for example, via the fiat currency ledger 1436. Such an account can be funded by transferring money from a bank account at a third-party bank to an account maintained by the service provider of FIG. 13 as is conventionally known. In some examples, a user can receive fiat currency in the form of payment for a transaction with another user. In such examples, at least a portion of such funds can be used to fund the fiat currency ledger 1436.

In some examples, a user can have one or more internal payment cards registered with the service provider of FIG. 13. Internal payment cards can be linked to one or more of the accounts associated with the user account 1420. In some embodiments, options with respect to internal payment cards can be adjusted and managed using an application (e.g., the payment application 1318).

In at least one example, as described above, each ledger can correspond to an account of the user that is managed by the service provider of FIG. 13. In at least one example, individual of the accounts can be associated with a wallet or a stored balance for use in payment transactions, peer-to-peer transactions, payroll payments, etc.

In at least one example, the user account 1420 can be associated with an asset wallet 1440. The asset wallet 1440 of the user can be associated with account information that can be stored in the user account data 1428 and, in some examples, can be associated with the user wallet key(s) 1432. In at least one example, the asset wallet 1440 can store data indicating an address provided for receipt of a cryptocurrency transaction. In at least one example, the balance of the asset wallet 1440 can be based at least in part on a balance of the asset ledger 1434. In at least one example, funds availed via the asset wallet 1440 can be stored in the asset wallet 1440 or the asset wallet 1410. Funds availed via the asset wallet 1410 can be tracked via the asset ledger 1434. The asset wallet 1440, however, can be associated with additional cryptocurrency funds.

In at least one example, when the service provider of FIG. 13 includes a private blockchain 1419 for recording and validating cryptocurrency transactions, the asset wallet 1440 can be used instead of, or in addition to, the asset ledger 1434. For example, at least one example, a merchant can provide the address of the asset wallet 1440 for receiving payments. In an example where a customer is paying in cryptocurrency and the customer has their own cryptocurrency wallet account associated with the service provider of FIG. 13, the customer can send a message signed by its private key including its wallet address (i.e., of the customer) and identifying the cryptocurrency and value to be transferred to the merchant’s asset wallet 1440. The service provider of FIG. 13 can complete the transaction by reducing the cryptocurrency balance in the customer’s cryptocurrency wallet and increasing the cryptocurrency balance in the merchant’s asset wallet 1440. In addition to recording the transaction in the respective cryptocurrency wallets, the transaction can be recorded in the private blockchain 1419 and the transaction can be confirmed. A user can perform a similar transaction with cryptocurrency in a peer-to-peer transaction as described above. In at least one example, the cryptocurrency wallet account 1430 can be funded by a balance transfer from a third-party cryptocurrency wallet, as described above. Such a transaction can require a user to transfer an amount of cryptocurrency in a message signed by the user’s private key to an address of the cryptocurrency wallet account 1430. The transferred amount of cryptocurrency can then be within the cryptocurrency wallet account 1430 for use in later transactions.

While the asset ledger 1434 and/or asset wallet 1440 are each described above with reference to cryptocurrency, the asset ledger 1434 and/or asset wallet 1440 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 13 is an aspect of the technology disclosed that enables technical advantages of increased processing speed and improved security.

FIG. 15 is an example environment 1500 for performing techniques described herein. In the environment 1500, the environment 1200 and the environment 1300 can be integrated to enable payments at the point-of-sale using assets associated with user accounts in the peer-to-peer environment of FIG. 13. As illustrated, each of the components can communicate with one another via one or more networks 1502. In some examples, one or more APIs 1504 or other functional components can be used to facilitate such communication.

In at least one example, the example environment 1500 can enable contactless payments, via integration of peer-to-peer payment, or other payment making, platform(s) and payment processing platform(s), are described herein. For the purpose of FIG. 15, the environment 1200 can refer to a payment processing platform and the environment 1300 can refer to a peer-to-peer payment, or payment making, platform. In an example, such an integration can enable a customer to participate in a transaction via their own computing device instead of interacting with a merchant device of a merchant, such as the merchant device 1208(A). In such an example, the POS application 1218, associated with a payment processing platform and executable by the merchant device 1208(A) of the merchant, can present a QR code, or other code that can be used to identify a transaction (e.g., a transaction code), in association with a transaction between th e customer and the merchant. The QR code, or other transaction code, can be provided to the POS application 1218 via an API associated with the peer-to-peer payment platform. In an example, the customer can utilize their own computing device, such as the user device 1308(A), to capture the QR code, or the other transaction code, and to provide an indication of the captured QR code, or other transaction code, to server(s) 1202 and/or server(s) 1302.

Based at least in part on the integration of th e peer-to-peer payment platform and the payment processing platform (e.g., via the API), the server(s) 1202 and/or 1302 associated with each can exchange communications with each other------and with a payment application 1318 associated with the peer-to-peer payment platform and/or the POS application 1218------to process payment for the transaction using a peer-to-peer payment where th e customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 1308(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1308(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1218 and the payment application 1318, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 1308(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 1218, associated with a payment processing platform, on the merchant device 1208(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 1208(A) can present a QR code, or other transaction code, that can be associated with a peer-to-peer payment platform. The customer can use a camera associated with the user device 1308(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction-between the customer computing device and the QR code-----can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 1218, associated with a payment processing platform, on the merchant device 1208(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 1218 can cause a text message with a resource locator (e.g., uniform resource locator (URL)) that can be associated with a peer-to-peer payment platform to be sent to the user device 1308(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction-between the customer and the resource locator presented via the customer computing device-can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 1308(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction between the customer computing device and the QR code-----can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 1218 of a merchant device 1208(A) at a brick-and-mortar store of a merchant to a payment application 1318 of a user device 1308(A) of a customer to enable the customer to participate in a transaction via their own computing device. For instance, in a “scan to pay” example as described above, based at least in part on capturing the QR code, or other transaction code, via the user device 1308(A), the payment processing platform can provide transaction data to the peer-to-peer payment platform for presentation via the payment application 1318 on the user device 1308(A). In some examples, the customer can watch items being added to their cart (e.g., via a user interface presented via the payment application). As an item is added to a virtual cart by the merchant—via the POS application 1218 on the merchant device 1208(A) of the merchant-----the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 1318 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 1308(A) during or after payment of the transaction.

In some examples, based at least in part on capturing the QR code, or other transaction code, the payment processing platform can provide transaction data to the peer-to-peer payment platform for presentation via the payment application 1318 on the computing device of the customer, such as the user device 1308(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of th e merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 1318 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above----and also below-----techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 1218, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1318 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

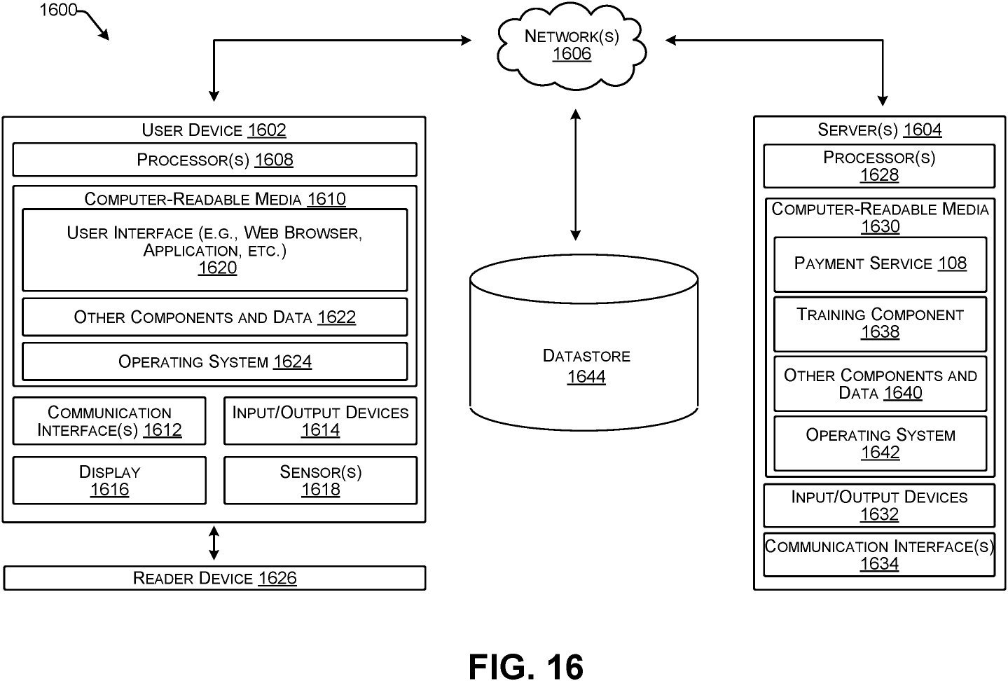

FIG. 16 is an example block diagram 1600 illustrating a system for performing techniques described herein. The block diagram 1600 illustrates a system 1600 for performing techniques described herein. The system 1600 includes a user device 1602, that communicates with server computing device(s) (e.g., server(s) 1604) via network(s) 1606 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1602 is illustrated, in additional or alternate examples, the system 1600 can have multiple user devices, as described above with reference to FIG. 12.

For example, the server(s) 1604 may be the same as or similar to the payment service computing platform 110 and/or the processing device(s) 114 (e.g., server(s)) introduced in FIG. 1, and the server(s) 1604 may implement the payment service 108, which may include the trained machine learning model(s) 122, the risk component 126, the incentive component 128, and/or the ranking component 130, as described herein. Furthermore, the network(s) 1606 may be the same as or similar to the network(s) 112 introduced in FIG. 1, and the user device 1602 may be the same as or similar to the electronic device 104 introduced in FIG. 1.

In at least one example, the user device 1602 can be any suitable type of computing device, e.g., portable, semi-portable, semi-stationary, or stationary. Some examples of the user device 1602 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1602 can be any computing device capable of sending communications and performing the functions according to the techniques described herein. The user device 1602 can include devices, e.g., payment card readers, or components capable of accepting payments, as described below.

In the illustrated example, the user device 1602 includes one or more processors 1608, one or more computer-readable media 1610, one or more communication interface(s) 1612, one or more input/output (I/O) devices 1614, a display 1616, and sensor(s) 1618.

In at least one example, each processor 1608 can itself comprise one or more processors or processing cores. For example, the processor(s) 1608 can be implemented as one or more microprocessors, microcomputers, microcontrollers, digital signal processors, central processing units, state machines, logic circuitries, and/or any devices that manipulate signals based on operational instructions. In some examples, the processor(s) 1608 can be one or more hardware processors and/or logic circuits of any suitable type specifically programmed or configured to execute the algorithms and processes described herein. The processor(s) 1608 can be configured to fetch and execute computer-readable processor-executable instructions stored in the computer-readable media 1610.

Depending on the configuration of the user device 1602, the computer-readable media 1610 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1610 can include, but is not limited to, RAM, ROM, EEPROM, flash memory, solid-state storage, magnetic disk storage, optical storage, and/or other computer-readable media technology. Further, in some examples, the user device 1602 can access external storage, such as RAID storage systems, storage arrays, network attached storage, storage area networks, cloud storage, or any other medium that can be used to store information and that can be accessed by the processor(s) 1608 directly or through another computing device or network. Accordingly, the computer-readable media 1610 can be computer storage media able to store instructions, components or components that can be executed by the processor(s) 1608. Further, when mentioned, non-transitory computer-readable media exclude media such as energy, carrier signals, electromagnetic waves, and signals per se.

The computer-readable media 1610 can be used to store and maintain any number of functional components that are executable by the processor(s) 1608. In some implementations, these functional components comprise instructions or programs that are executable by the processor(s) 1608 and that, when executed, implement operational logic for performing the actions and services attributed above to the user device 1602. Functional components stored in the computer-readable media 1610 can include a user interface 1620 to enable users to interact with the user device 1602, and thus the server(s) 1604 and/or other networked devices. In at least one example, the user interface 1620 can be presented via a web browser, or the like. In other examples, the user interface 1620 can be presented via an application, such as a mobile application or desktop application, which can be provided by a service provider associated with the server(s) 1604, or which can be an otherwise dedicated application. In some examples, the user interface 1620 can be any of the user interfaces 118, 400, and/or 402 described herein. In at least one example, a user can interact with the user interface via touch input, spoken input, gesture, or any other type of input. The word “input” is also used to describe “contextual” input that may not be directly provided by the user via the user interface 1620. For example, user’s interactions with the user interface 1620 are analyzed using, e.g., natural language processing techniques, to determine context or intent of the user, which may be treated in a manner similar to “direct” user input.

Depending on the type of the user device 1602, the computer-readable media 1610 can also optionally include other functional components and data, such as other components and data 1622, which can include programs, drivers, etc., and the data used or generated by the functional components. In addition, the computer-readable media 1610 can also store data, data structures and the like, that are used by the functional components. Further, the user device 1602 can include many other logical, programmatic and physical components, of which those described are merely examples that are related to the discussion herein.

In at least one example, the computer-readable media 1610 can include additional functional components, such as an operating system 1624 for controlling and managing various functions of the user device 1602 and for enabling basic user interactions.

The communication interface(s) 1612 can include one or more interfaces and hardware components for enabling communication with various other devices, such as over the network(s) 1606 or directly. For example, communication interface(s) 1612 can enable communication through one or more network(s) 1606, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1606 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1602 can further include one or more input/output (I/O) devices 1614. The I/O devices 1614 can include speakers, a microphone, a camera, and various user controls (e.g., buttons, a joystick, a keyboard, a keypad, etc.), a haptic output device, and so forth. The I/O devices 1614 can also include attachments that leverage the accessories (audio-jack, USB-C, Bluetooth, etc.) to connect with the user device 1602.

In at least one example, user device 1602 can include a display 1616. Depending on the type of computing device(s) used as the user device 1602, the display 1616 can employ any suitable display technology. For example, the display 1616 can be a liquid crystal display, a plasma display, a light emitting diode display, an OLED (organic light-emitting diode) display, an electronic paper display, or any other suitable type of display able to present digital content thereon. In at least one example, the display 1616 can be an augmented reality display, a virtually reality display, or any other display able to present and/or project digital content. In some examples, the display 1616 can have a touch sensor associated with the display 1616 to provide a touchscreen display configured to receive touch inputs for enabling interaction with a graphic interface presented on the display 1616. Accordingly, implementations herein are not limited to any particular display technology. Alternatively, in some examples, the user device 1602 may not include the display 1616, and information can be presented by other means, such as aurally, hapticly, etc.

In addition, the user device 1602 can include sensor(s) 1618. The sensor(s) 1618 can include a GPS device able to indicate location information. Further, the sensor(s) 1618 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 612, described above, to provide one or more services. That is, in some examples, the service provider 612 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 614 and/or for sending users 614 notifications regarding available appointments with merchant(s) located proximate to the users 614. In at least one example, location can be used for taking payments from nearby customers when they leave a geofence, or location can be used to initiate an action responsive to users 614 enter a brick-and-mortar store of a merchant. Location can be used in additional or alternative ways as well.

Additionally, the user device 1602 can include various other components that are not shown, examples of which include removable storage, a power source, such as a battery and power control unit, a barcode scanner, a printer, a cash drawer, and so forth.

In addition, in some examples, the user device 1602 can include, be connectable to, or otherwise be coupled to a reader device 1626, for reading payment instruments and/or identifiers associated with payment objects. In some examples, as described above, the reader device 1626 can plug in to a port in the user device 1602, such as a microphone port, a headphone port, an audio-jack, a data port, or other suitable port. In additional or alternative examples, the reader device 1626 can be coupled to the user device 1602 via another wired or wireless connection, such as via a Bluetooth®, BLE, and so on. The reader device 1626 can include a read head for reading a magnetic strip of a payment card, and further can include encryption technology for encrypting the information read from the magnetic strip. Additionally or alternatively, the reader device 1626 can be an EMV payment reader, which in some examples, can be embedded in the user device 1602. Moreover, numerous other types of readers can be employed with the user device 1602 herein, depending on the type and configuration of the user device 1602.

The reader device 1626 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1626 may include hardware implementation, such as slots, magnetic tracks, and rails with one or more sensors or electrical contacts to facilitate detection and acceptance of a payment instrument. That is, the reader device 1626 may include hardware implementations to enable the reader device 1626 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 1626 may also include a biometric sensor to receive and process biometric characteristics and process them as payment instruments, given that such biometric characteristics are registered with the payment service system 100 and connected to a financial account with a bank server.

The reader device 1626 may include processing unit(s), computer-readable media, a reader chip, a transaction chip, a timer, a clock, a network interface, a power supply, and so on. The processing unit(s) of the reader device 1626 may execute one or more components and/or processes to cause the reader device 1626 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1626, the computer-readable media may include volatile memory (such as RAM), non-volatile memory (such as ROM, flash memory, miniature hard drive, memory card, or the like), or some combination thereof. In at least one example, the computer-readable media of the reader device 1626 may include at least one component for performing various functions as described herein.

The reader chip may perform functionalities to control the operations and processing of the reader device 1626. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 1612, which may provide a clock signal indicating a time. Furthermore, the reader chip may perform functionality to control the network interface, which may interface with the network(s) 1606, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1626. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 1602, which can be a POS terminal, and the reader device 1626 are shown as separate devices, in additional or alternative examples, the user device 1602 and the reader device 1626 can be part of a single device, which may be a battery-operated device. In such an example, components of both the user device 1602 and the reader device 1626 may be associated with the single device. In some examples, the reader device 1626 can have a display integrated therewith, which can be in addition to (or as an alternative of) the display 1616 associated with the user device 1602.

The server(s) 1604 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1604 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1604 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1604 can include one or more processors 1628, one or more computer-readable media 1630, one or more I/O devices 1632, and one or more communication interfaces 1634. Each processor 1628 can be a single processing unit or a number of processing units, and can include single or multiple computing units or multiple processing cores. The processor(s) 1628 can be implemented as one or more microprocessors, microcomputers, microcontrollers, digital signal processors, central processing units, state machines, logic circuitries, and/or any devices that manipulate signals based on operational instructions. For example, the processor(s) 1628 can be one or more hardware processors and/or logic circuits of any suitable type specifically programmed or configured to execute the algorithms and processes described herein. The processor(s) 1628 can be configured to fetch and execute computer-readable instructions stored in the computer-readable media 1630, which can program the processor(s) 1628 to perform the functions described herein.

The computer-readable media 1630 can include volatile and nonvolatile memory and/or removable and non-removable media implemented in any type of technology for storage of information, such as computer-readable instructions, data structures, program components, or other data. Such computer-readable media 1630 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1604, the computer-readable media 1630 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1630 can be used to store any number of functional components that are executable by the processor(s) 1628. In many implementations, these functional components comprise instructions or programs that are executable by the processors 1628 and that, when executed, specifically configure the one or more processors 1628 to perform the actions attributed above to the service provider 612 and/or payment processing service. Functional components stored in the computer-readable media 1630 can optionally include a payment service 108 (including the sub-components 126, 128, and/or 130, and/or the trained machine learning model 122 depicted in FIG. 1), a training component 1638, and one or more other components and data 1640.

The training component 1638 can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1602 and/or the server(s) 1604 for use at a time after the data models have been trained (e.g., at runtime).

The one or more other components and data 1640 can include the sub-components of the payment service 108, the functionality of which is described, at least partially, above. Further, the one or more other components and data 1640 can include a merchant component configured to receive transaction data from POS systems, such as the POS system 1224 described above with reference to FIG. 12. Such a merchant component can transmit requests (e.g., authorization, capture, settlement, etc.) to payment service server computing device(s) to facilitate POS transactions between merchants and customers. Such a merchant component can communicate the successes or failures of the POS transactions to the POS systems. Further, the one or more other components and data 1640 can include programs, drivers, etc., and the data used or generated by the functional components. Further, the server(s) 1604 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1630 can additionally include an operating system 1642 for controlling and managing various functions of the server(s) 1604.

The communication interface(s) 1634 can include one or more interfaces and hardware components for enabling communication with various other devices, such as over the network(s) 1606 or directly. For example, communication interface(s) 1634 can enable communication through one or more network(s) 1606, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1602 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1604 can further be equipped with various I/O devices 1632. Such I/O devices 1632 can include a display, various user interface controls (e.g., buttons, joystick, keyboard, mouse, touch screen, biometric or sensory input devices, etc.), audio speakers, connection ports and so forth.

In at least one example, the system 1600 can include a datastore 1644 that can be configured to store data that is accessible, manageable, and updatable. The data store 1644 may be the same as or similar to the data store(s) 116 introduced in FIG. 1. In some examples, the datastore 1644 can be integrated with the user device 1602 and/or the server(s) 1604. In other examples, as shown in FIG. 16, the datastore 1644 can be located remotely from the server(s) 1604 and can be accessible to the server(s) 1604. The datastore 1644 can comprise multiple databases and/or servers connected locally and/or remotely via the network(s) 1606.

In at least one example, the datastore 1644 can store user profiles, which can include merchant profiles, customer profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 612.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

In at least one example, the account(s) can include or be associated with the merchant profiles and/or customer profiles described above.

Furthermore, in at least one example, the datastore 1644 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1644 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

What is claimed is:

1. A computer-implemented method for reducing fraud in association with user account creation, the computer-implemented method comprising:
receiving, by a payment service computing platform associated with a payment service, and from an electronic device executing a payment application associated with the payment service, user data associated with a user via an onboarding process facilitated by the payment service;
determining, by the payment service computing platform, and based on analyzing the user data using a trained machine learning model, a risk metric associated with the user, wherein the trained machine learning model is trained based on previously collected user data associated with created user accounts;
based on the risk metric determined using the trained machine learning model, dynamically generating, by the payment service computing platform, an incentive associated with the user;
causing, by the payment service computing platform, a user interface to be displayed via the payment application executing on the electronic device, wherein the user interface presents an interactive element for receiving the incentive in exchange for the user referring at least one other user to the payment service;
sending, by the payment service computing platform, and in response to an interaction with the interactive element, an invitation to the at least one other user;
monitoring, in near real-time, invitation data indicating acceptances of one or more invitations; and
determining, based on the incentive and the invitation data, an amount of funds to transfer from a payment service account of the payment service to a user account of the user.

2. The computer-implemented method of claim 1, further comprising:
determining, by the payment service computing platform, a characteristic associated with the user based on the user data,
wherein the dynamically generating the incentive is further based on the characteristic.

3. The computer-implemented method of claim 2, wherein the characteristic comprises a geolocation, a spending limit, or an affiliation with an entity.

4. The computer-implemented method of claim 1, wherein the user data comprises one or more of a phone number, an electronic mail address, an Internet Protocol address, a geolocation, a payment card number, a bank account number, a personal name of the user, or contacts listed in contacts of the user.

5. The computer-implemented method of claim 1, wherein the previously collected user data comprises one or more of types of networks used during the onboarding process, versions of the payment application used during the onboarding process, or numbers of contacts in which a phone number is found during the onboarding process.

6. A system comprising:
one or more processors; and
computer-executable instructions that, when executed by the one or more processors, cause the one or more processors to perform operations comprising:
receiving, from an electronic device, user data associated with a user;
dynamically determining, based at least in part on the user data and using a trained machine learning model, an incentive associated with the user; and
causing a user interface to be displayed via a payment application executing on the electronic device, wherein the user interface presents an interactive element for receiving the incentive in exchange for the user referring at least one other user to a payment service.

7. The system of claim 6, the operations further comprising:
determining a characteristic associated with the user based at least in part on the user data,
wherein the dynamically determining the incentive is further based at least in part on the characteristic.

8. The system of claim 6, wherein the user data is received during an onboarding process for onboarding the user to a payment service and the user data comprises a phone number or an electronic mail address.

9. The system of claim 6, the operations further comprising
determining, based at least in part on the user data, a risk metric associated with the user,
wherein the dynamically determining the incentive is based at least in part on the risk metric.

10. The system of claim 9, wherein:
the trained machine learning model is a second trained machine learning model;
the determining the risk metric is further based at least in part on analyzing the user data using a first trained machine learning model;
the operations further comprise:
querying an external service using the user data; and
receiving, from the external service, additional user data about the user; and
the determining the risk metric is further based at least in part on analyzing the additional user data using the first trained machine learning model.

11. The system of claim 6, wherein the incentive is dynamically determined at a first time, the operations further comprising:
at least one of:
determining that a period of time has lapsed since the first time; or
receiving, at a second time after the first time, additional user data associated with the user; and
modifying the incentive based at least in part on at least one of:
the determining that the period of time has lapsed; or
the receiving of the additional user data.

12. The system of claim 6, wherein:
the at least one other user is a first contact of the user;
the incentive is a first incentive associated with the user and the first contact;
the operations further comprise dynamically determining a second incentive associated with the user and a second contact of the user;
the interactive element is a first interactive element; and
the user interface presents a second interactive element for receiving the second incentive in exchange for the user referring the second contact to the payment service.

13. The system of claim 12, wherein the second incentive is different than the first incentive based at least in part on an affinity metric associated with the second contact being different than an affinity metric associated with the first contact.

14. The system of claim 6, wherein:
the at least one other user is a first contact of the user;
the operations further comprise ranking contacts of the user in a ranked order, the contacts including at least the first contact and a second contact;
the interactive element is a first interactive element; and
the user interface presents a second interactive element for receiving the incentive or a different incentive in exchange for the user referring the second contact to the payment service, wherein the first interactive element and the second interactive element are positioned in the user interface based at least in part on the ranked order.

15. A computer-implemented method comprising:
receiving, by a payment service computing platform associated with a payment service, and from an electronic device, user data associated with a user;
dynamically determining, by the payment service computing platform, based at least in part on the user data and using a trained machine learning model, an incentive associated with the user; and
causing, by the payment service computing platform, a user interface to be displayed via a payment application executing on the electronic device, wherein the user interface presents an interactive element for receiving the incentive in exchange for the user referring at least one other user to the payment service.

16. The computer-implemented method of claim 15, wherein the incentive comprises at least one of a fiat currency, a gift, a coupon, a discount, loyalty points, a status, a stock, a bond, a mutual fund, an exchange-traded fund (ETF), a cryptocurrency, a non-fungible token (NFT), or a purchase.

17. The computer-implemented method of claim 15, wherein:
the at least one other user is a first contact of the user;
the incentive is a first incentive associated with the user and the first contact;
the computer-implemented method further comprises dynamically determining a second incentive associated with the user and a second contact of the user;
the interactive element is a first interactive element; and
the user interface presents a second interactive element for receiving the second incentive in exchange for the user referring the second contact to the payment service.

18. The computer-implemented method of claim 15, wherein:
the at least one other user is a first contact of the user;
the computer-implemented method further comprises ranking contacts of the user in a ranked order, the contacts including at least the first contact and a second contact;
the interactive element is a first interactive element; and
the user interface presents a second interactive element for receiving the incentive or a different incentive in exchange for the user referring the second contact to the payment service, wherein the first interactive element and the second interactive element are positioned in the user interface based at least in part on the ranked order.

19. The computer-implemented method of claim 15, further comprising
determining, by the payment service computing platform, and based at least in part on the user data, a risk metric associated with the user,
wherein the dynamically determining the incentive is based at least in part on the risk metric.

20. The computer-implemented method of claim 19, wherein:
the trained machine learning model is a second trained machine learning model; and
the determining the risk metric is further based at least in part on analyzing the user data using a first trained machine learning model.
